(19) United States
(12) Patent Application Publication
(10) Pub. No.: US 2026/0319990 A1
(43) Pub. Date: Oct. 15, 2026

(54) BRIDGE NODE FOR SERIAL COMMUNICATION IN A DAISY CHAIN

(71) Applicant: ams-OSRAM International GmbH, Regensburg (DE)

(72) Inventors: Daniel DIETZE, Regensburg (DE); Markus KOESLER, Landshut (DE); Massimo RIGO, Trieste (IT); Matteo COLOMBO, Verrua Po (IT)

(21) Appl. No.: 19/484,393

(22) PCT Filed: Nov. 4, 2024
(86) PCT No.: PCT/EP2024/081024

§ 371 Date: Nov. 14, 2025

(30) Foreign Application Priority Data
Nov. 20, 2023 (DE) 10 2023 132 234.6

(51) Int. Cl. G06F 13/40; G06F 13/38; G06F 13/42

(52) U.S. Cl. CPC G06F 13/4045; G06F 13/387; G06F 13/4247

(57) ABSTRACT

The present disclosure relates to a serial communication network, including: a plurality of network nodes including a primary node and one or more secondary nodes connected in a daisy chain configuration and configured to communicate according to a first wired communication protocol for serial communication; wherein at least one of the network nodes is configured to act as bridge node to: enable a communicative coupling with a network node and with an external device, receive from the network node a first message according to the first wired communication protocol, and embed data from the first message into a second message configured according to a second wired communication protocol; and/or receive from the external device a second message configured according to the second wired communication protocol, and embed data from the second message into a first message configured according to the first wired communication protocol.

### TECHNICAL FIELD

The present disclosure relates generally to an electronic device configured to act as a bridge node in a serial communication network to enable communication with a third-party device, and to a serial communication network including one or more electronic devices acting as bridge node(s).

### BACKGROUND

In general, many applications are based on the interplay of interconnected devices that act in concert to provide a certain functionality. An example of such a system are the so-called “smart surfaces”, a new type of human machine interface (HMI) that find applications in particular in the automotive context and industrial context. In a “smart surface” hundreds of light emitting diodes (LEDs) are controlled to dynamically and adaptively show information to a user, and sensors and actuators allow capturing inputs and commands from the user. In a system including many interconnected devices, communication protocols may regulate the data transfer among devices, thus ensuring a reliable communication and avoiding potential conflicts. In particular, in the context of systems including sensors, actuators, light emitting devices, etc. the data transfer among devices may occur via a wired connection (e.g., via a single-wire or via a plurality of wires), so that the connected devices may communicate according to a wired communication protocol that defines the rules for transmitting data. Improvements in communication strategies for wired-based communication may thus be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A and FIG. 1B show a serial network system having a daisy chain network topology, in a schematic representation according to various aspects;

FIG. 2A shows a network node, in a schematic representation according to various aspects;

FIG. 2B shows an exemplary configuration of the network node, in a schematic representation according to various aspects;

FIG. 2C shows an exemplary configuration of the input/output ports of the network node, in a schematic representation according to various aspects;

FIG. 2D shows an exemplary configuration of electrically conductive lines connected with the network node, in a schematic representation according to various aspects;

FIG. 3A to FIG. 3C show a network node configured to act as bridge node, in a schematic representation according to various aspects;

FIG. 4A to FIG. 4H show possible dispositions of a bridge node within a daisy chain network, in a schematic representation, according to various aspects;

FIG. 5A and FIG. 5B show a system including a daisy chain network with a bridge node and one or more external devices coupled with the bridge node, in a schematic representation, according to various aspects; and

FIG. 6A to FIG. 6E show a conversion from a message according to a first communication protocol into a message according to a second communication protocol, and vice versa, according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects.

In general, networks of interconnected devices that communicate with one another via a wired connection and according to a wired communication protocol play an important role in a variety of applications, such as in lighting systems, sensor systems, and the like. In this context, many communication protocols have been defined over the years to control the transfer of data among the networked devices. Broadly speaking, communication protocols may be divided in two main categories, parallel or serial. A parallel interface allows transferring multiple bits in parallel, whereas serial interfaces operate at a lower data rate (e.g., transferring a single bit at a time), e.g., considering the scenario of equal clock frequency.

With respect to parallel architectures, serial communication for a wired network may be implemented via a simpler setup (e.g., using a single wire, or in general less wires compared to parallel communication), and thus at a fraction of the cost. Serial communication may thus be of particular interest for wired network systems involving large numbers of interconnected devices.

Various options exist for serial network topologies, illustratively for the physical and/or logical arrangement of the nodes forming the communication network. The network topology may thus describe the path or paths available for a signal to travel through the network of interconnected nodes. In this context, the term “network node” may describe an electronic device that is part of the network. A “network node” may thus be an electronic device that includes communication circuitry to enable communication with other electronic devices (other nodes) that are part of the network. A “network node” may further include any suitable circuitry to implement additional functionalities, e.g. for carrying out a certain function or operation. As an example, considering a network of lighting fixtures, a network node may include a light emitting circuit configured to emit light. As another example, considering a network of sensor devices, a network node may include a sensing circuit configured to sense (or detect) a certain physical quantity such as temperature, light, mechanical vibrations, etc. A “network node” may also be referred to herein simply as “node”. It is understood that aspects described herein in relation to a “network node” may apply to the electronic device constituting that network node, and vice versa.

A simple topology is the so-called “point-to-point topology”, in which exactly two nodes are directly connected (in other words linked) to one another. A further example may be the “star topology” in which each peripheral network node is connected to a central network node via an individual transmission line. A further example may be the “bus topology” in which the network nodes are connected to a common transmission line (illustratively, a common bus). In the “bus topology” several network nodes are connected at the same line providing a parallel connection of the network nodes. Further examples may be a “tree topology” or a “mesh topology”. So-called “hybrid topologies” that combine two or more types of topologies may also be provided.

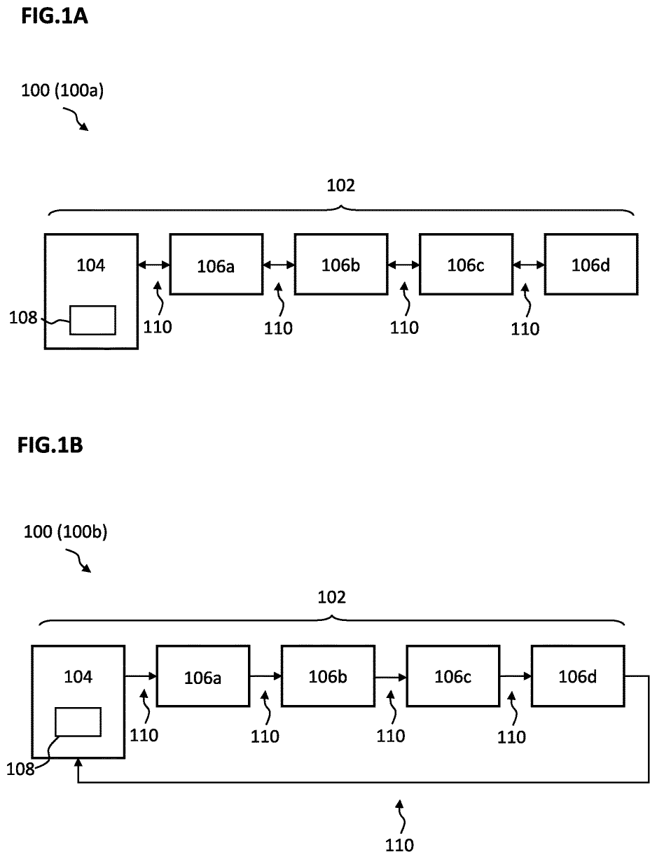

In this context, an advantageous network topology for interconnecting electronic devices is the so-called “daisy chain topology” (see also FIG. 1A and FIG. 1B). In a daisy chain configuration the network nodes may be connected to form a series of nodes, in which each network node may be connected via a point-to-point connection with one or two further network nodes, illustratively a preceding node and/or a subsequent node in the series of serially connected nodes.

A “daisy chain topology” may be “linear”, such that a first node is connected to a second node, the second node is further connected to a third node, the third node is further connected to a fourth node, etc. until the final node of the series is reached. The “linear configuration” may thus be a bidirectional network configuration in which each network node is connected to the next in the series (illustratively, in a line, or chain), and the communication runs through the series of connected nodes and then returns along the same path. In this configuration the first node and the last node are not directly connected.

As another example a “daisy chain topology” may have a “ring configuration”, such that a first node is connected to a second node, the second node is further connected to a third node, the third node is further connected to a fourth node, etc. and the final node of the series is connected back to the first node. The “ring configuration” may thus define a loop-back network, in which the network nodes are connected in series, and the last node is connected back to the first node, so that communication runs through the sequence of nodes in one direction and then loops back to the first node. In the ring topology, every network node may thus be connected to two other nodes, with the first node and the last node being connected to one another.

A “daisy chain topology” may enable a cost-effective and scalable architecture for providing a network configured according to serial communication. In particular, a “daisy chain topology” may be realized with a reduced number of terminals and connection lines compared to other configurations, thus providing a cost- and resource-efficient implementation.

Therefore, wired networks having a daisy chain topology and based on serial communication are attractive for applications in which space and costs considerations may play an important role. In this framework, improved communication strategies for such type of networks may lead to a more cost- and resource-efficient operation, thus facilitating the integration of such systems in a variety of application scenarios.

In general, many communication protocols exist for governing wired-based serial communication. As a trait common to many communication protocols, wired-based serial communication may involve one network node acting as “primary node” and one or more other network nodes acting as “secondary nodes”.

In this context, the term “primary” may be used to describe the network node (illustratively, the corresponding electronic device) configured to control the operation of the other network nodes. The “primary node” may thus be configured to govern the transmission and the reception of data in the network, e.g. a “primary node” may be configured to transmit data to the one or more other “secondary nodes” and may be configured to request the transmission of data from the one or more other “secondary nodes”. A “primary node” may be understood as a device configured to instruct the operation of the one or more “secondary nodes” (e.g., providing instructions prompting the execution of one or more operations). A “primary node” may also be referred to herein as “master node”, “controller node”, “leader node”, or “host node”. In some aspects, a “primary node” may also be referred to herein as electronic control unit (ECU). As an example, a “primary node” may include a microcontroller or any other suitable processing circuitry (e.g., a field programmable gate array, FPGA, an application specific integrated circuit, ASIC, etc.) to control the other nodes, e.g., to transmit instructions to the other nodes.

The term “secondary” may be used to describe a network node configured to be instructed by another network node, illustratively by the “primary node”. A “secondary node” may be a network node configured to receive instructions and to respond to the received instructions (e.g., without performing any active data transmission in absence of a prompt from the primary node). In some aspects, a “secondary node” may be configured to transmit data (e.g., various types of information), e.g. upon request from the primary node. A “secondary node” may also be referred to herein as “slave node”, “peripheral node”, “follower node”, or “responder node”.

In general, a wired communication protocol for serial communication may define a set of rules for controlling the data transfer among the network nodes. A wired communication protocol for serial communication may thus define the types of commands that may be sent/received, the types of responses to the different commands, the timing of the data transfer (e.g., synchronous or asynchronous), the layers for the communication, the type of coding for the data transfer, and the like. The type of node-to-node connection and the communication circuitry of a node may be adapted depending on the communication protocol according to which the nodes are configured.

Examples of communication protocols for wired-based serial communication may include the Inter-Integrated Circuit bus (I²C) protocol (e.g., according to I2C-bus specification and user manual Rev. 7.0 of 1 Oct. 2021), the Serial Peripheral Interface (SPI) protocol, the single-wire (1-wire, or one-wire) protocol, the Controller Area Network (CAN) protocol, the Ethernet protocol, and/or the microwire protocol. Some of these protocols (e.g., the I²C protocol) may also support parallel communication.

Recently, a further communication protocol has been defined for wired-based serial communication, the so-called Open System Protocol (OSP). OSP may be used in a variety of implementations and has broad applicability. In one common implementation, OSP may be utilized in the context of a single microprocessor (as “primary node”) and multiple smart light emitting diode (LED) devices (as “secondary nodes”). The OSP defines a system architecture, commands, and data structure tailored to devices interconnected according to daisy chain network topology, and may thus enable a robust and efficient data transfer in such type of networks.

Aspects of the present disclosure may be based on the realization that many applications in modern systems do not rely on a single functionality, but are rather based on an interplay of different functionalities provided by different types of electronic devices. This may be the case, for example, for applications such as “smart surfaces”, which are based on the combination of many LEDs (several hundreds) and sensor/actuator elements catering the human-machine interface part. In a “smart surface” or, more in general, in a system including multiple parts dedicated to different functionalities, each portion may be served by dedicated microcontrollers and dedicated wiring for implementing communication among the devices of that portion. For a smart surface, as an example, the LED portion and the HMI portion may include respective microcontrollers and wirings.

Therefore, in a “multi-function” system, each functionality may be provided by a dedicated set of electronic devices, wherein each set may form or be part of a separate “network”, for example a separate wired-based communication network. In this regard, the presence of multiple microcontrollers and wiring systems may lead to a more complex and overall more expensive arrangement, which may be a particularly relevant drawback in networked systems that already include a large number of interconnected elements.

Aspects of the present disclosure may be based on the realization that in a daisy chain network configured according to wired-based serial communication, one of the network nodes (or a plurality of network nodes) may be configured to act as “bridge node” to provide an interface between the daisy chain network and an external electronic device that is not part of the daisy chain network. The electronic device external to the daisy chain network may be an individual electronic device, or may be itself part of a further network (illustratively, the external electronic may be a network node of a different network).

A “bridge node” may thus be configured to be communicatively coupled with the external electronic device, and to allow a data transfer from the daisy chain network to the external electronic device and from the external electronic device to the daisy chain network. The “bridge node” may illustratively provide a bridging functionality by translating messages defined according to the communication protocol of the daisy chain network into messages according to the communication protocol of the external device, and vice versa.

By introducing a “bridge node” in any position within a daisy chain of network nodes, external third party devices may be communicatively coupled with the daisy chain network without the need for additional wires or controllers, thus providing a simplified layout. Illustratively, the “bridge node” allows using the already existing circuitry and wirings for communicating with the external electronic device (or external network), so that no extra wires are needed. Furthermore, in this configuration a controller of the daisy chain network may send instructions to the external device via the bridge node, and may receive response messages from the external device via the bridge node. The bridge node thus allows using the controller already present in the daisy chain network for instructing an operation of the external device, thus saving cost and space that would otherwise be needed for an additional dedicated controller.

By way of illustration, the network nodes of the daisy chain network may be configured to communicate with one another according to a first wired communication protocol for serial communication, and the external electronic device may be configured to communicate according to a second wired communication protocol, different from the first wired communication protocol. The bridge node may translate messages according to the first wired communication protocol into messages according to the second wired communication protocol for delivering the translated messages to the external electronic device, and may translate messages according to the second wired communication protocol into messages according to the first wired communication protocol for delivering the translated messages to the daisy chain network.

In a preferred configuration, the first wired communication protocol for serial communication may be the Open System Protocol (e.g., according to OSRE® E3731i—Open System Protocol 1.0, Application Note AN162 of 2023-07-06). Aspects of the present disclosure may illustratively be based on the realization that the OSP defines rules that facilitate the configuration of a network node as “bridge node”. For example, the OSP may define a message frame format that allows inserting data extracted from messages according to other communication protocols in a simple and efficient manner. In this regard, the bridge node may allow controlling third party devices (e.g., integrated circuits) that would otherwise not support the OSP protocol by using the bridge node to deliver to such devices (e.g., sensors) messages that they are capable of interpreting and reacting to.

Thus, in the present disclosure particular reference may be made to a daisy chain network in which the network nodes are configured to communicate with one another according to the Open System Protocol, as this may be the most relevant use case for the proposed configuration. In the following, use may be made of concepts and terminology that pertain to the OSP. It is however understood that the aspects described herein may be broadly applied to other types of wired communication protocols, e.g. other wired communication protocols for serial communication. Furthermore, some examples may refer to specific wired communication protocols (e.g., to a specific version or release of a wired communication protocol), but it is understood that the examples provided herein may be similarly applied to various other wired communication protocols or other versions/releases of the wired communication protocols, both existing and not yet formulated.

Further, in a preferred configuration the network nodes of the daisy chain network may include a light emitting circuit (e.g., one or more light emitting diodes, LEDs). Illustratively, the network architecture with a bridge node proposed herein may be of particular interest for daisy chain-connected light fixtures, to allow a simple and efficient coupling of third party devices with the lighting network. This arrangement may be provided, for example, for a “smart surface” (e.g., in a vehicle), in which the presence of a “bridge node” allows using the controller and wiring of the lighting network for communicating with external devices, such as sensors and actuators. It is however understood that the configuration proposed herein may be applied to any suitable type of network node, e.g. to a network node configured to implement any suitable functionality.

FIG. 1A and FIG. 1B show a serial communication network 100 in a schematic representation, according to various aspects. In general, the serial communication network 100 may include a plurality of network nodes 102 disposed according to a daisy chain configuration. Illustratively, the network nodes 102 may be connected to form a series of network nodes, such that each network node 102 is connected with one or two other network nodes 102, and a data transfer within the network may include a propagation of the data from one network node 102 to the next node in the chain. In this regard, the serial communication network 100 may have a “linear” daisy chain topology, as shown for the configuration 100a in FIG. 1A, or a “ring” daisy chain topology, as shown for the configuration 100b in FIG. 1B.

According to the “linear” daisy chain topology, a first node 104 may be connected to a second node 106a, the second node 106a may be further connected to a third node 106b, etc. until a last node 106d is reached. As mentioned above, in this configuration the last node 106d and the first node 104 are not directly connected, and the communication between nodes may be bidirectional, thus allowing a flow of information from the first node 104 towards the last node 106d, and vice versa.

According to the “ring” daisy chain topology, the first node 104 may be connected to the second node 106a, the second node 106a may be further connected to the third node 106b, etc. until the last node 106d is reached. As mentioned above, in this configuration the last node 106d and the first node 104 may be directly connected, providing a loop-back arrangement. In this configuration, the communication between nodes may be unidirectional, thus allowing a flow of information from the first node 104 towards the last node 106d, and then a loop-back of the information from the last node 106d to the first node 104.

A serial communication network with a linear daisy chain topology, and a serial communication network with a ring daisy chain topology may be collectively referred to as serial communication network. A “serial communication network” may also be referred to herein as “wired communication network”, “daisy chain network”, or simply as “communication network” or “network”.

The exemplary configurations in FIG. 1A and FIG. 1B show a network 100 with five nodes 102, but it is understood that the network 100 may include any suitable number of nodes. As an example, the strategy proposed herein may be of particular relevance for networks including a relatively large number of nodes, e.g. the network 100 may include a number of network nodes 102 in the range from 100 to 5000, e.g. in the range from 200 to 2000, e.g. in the range from 300 to 1000.

According to various aspects, the network nodes 102 may include a primary node 104 and one or more secondary nodes 106a-106d (illustratively, a master node 104 and one or more slave nodes 106a-106d), e.g. a plurality of secondary nodes 106a-106d. As mentioned, the primary node 104 may govern the communication within the network 100. For example, the primary node 104 may include control circuitry 108 configured to control a communication within the network 100, e.g. configured to control a data transfer over the daisy chain of network nodes 102. Illustratively, the control circuitry 108 may be configured to cause a transmission of messages along the chain of secondary nodes 106a-106d, and to prompt a response from one or more of the secondary nodes 106a-106d. The primary node 104 may further include communication circuitry (not shown) to send/receive data to/from the chain of secondary nodes 106a-106d. As an exemplary realization, the primary node 104 may be or include a microcontroller, e.g. a microcontroller unit (MCU). In some aspects, the primary node 104 may be a unique node within the network 100. In some aspects, the primary node 104 may be further connected to a backbone network.

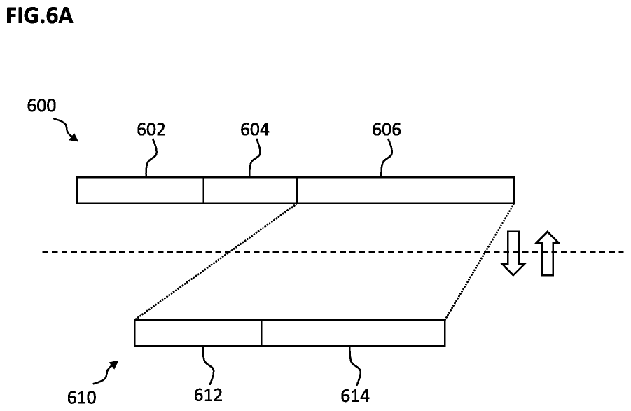

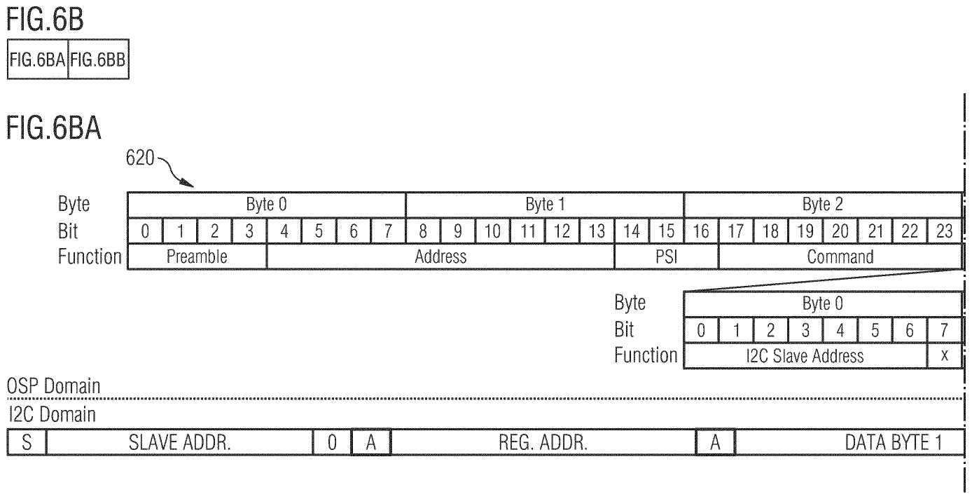

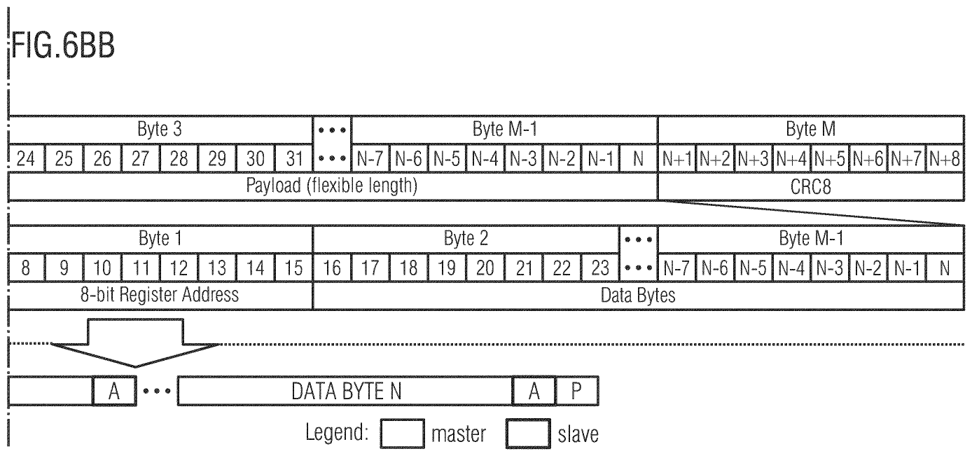

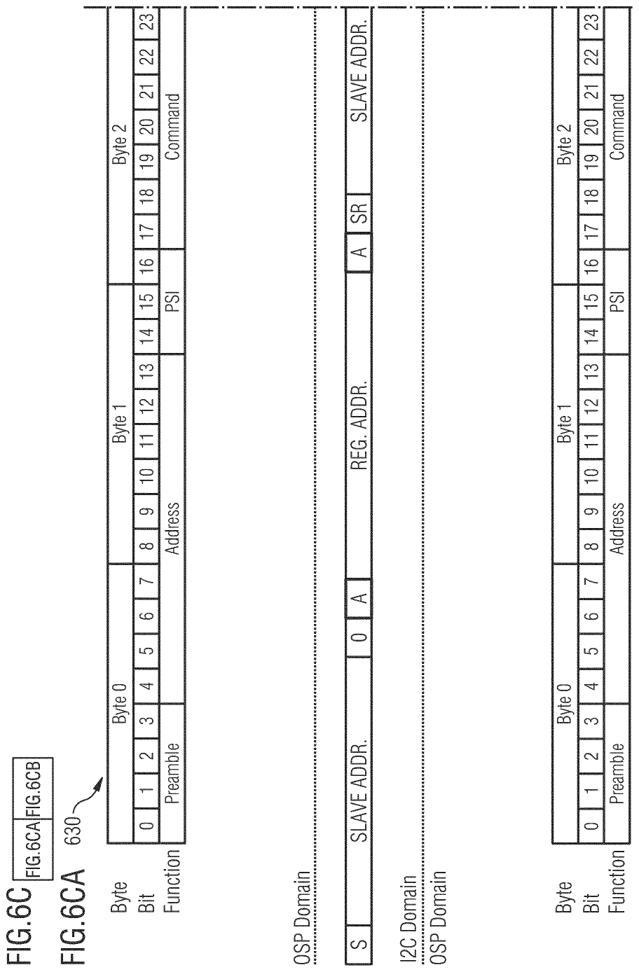

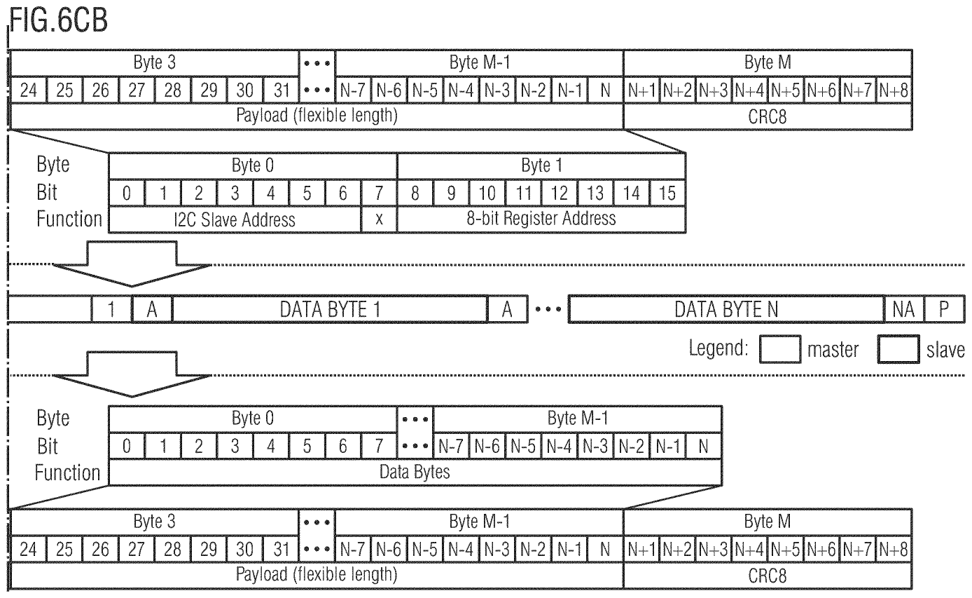

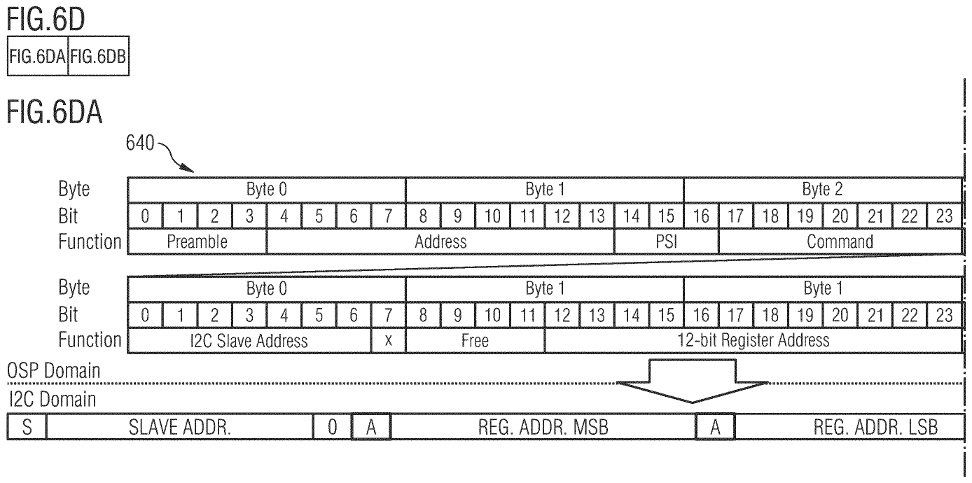

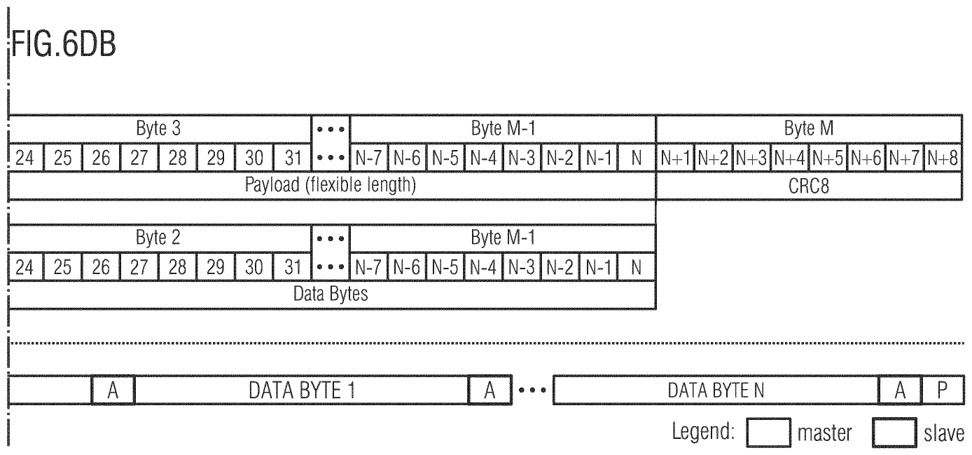

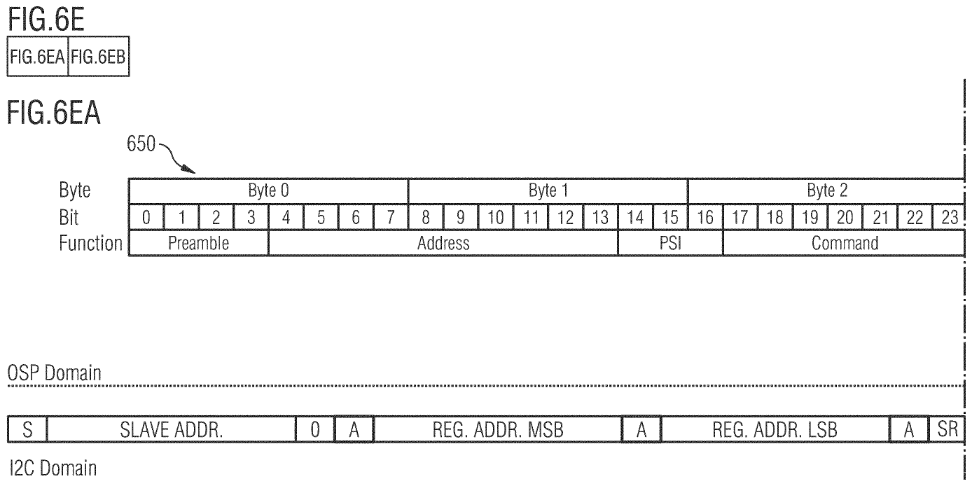

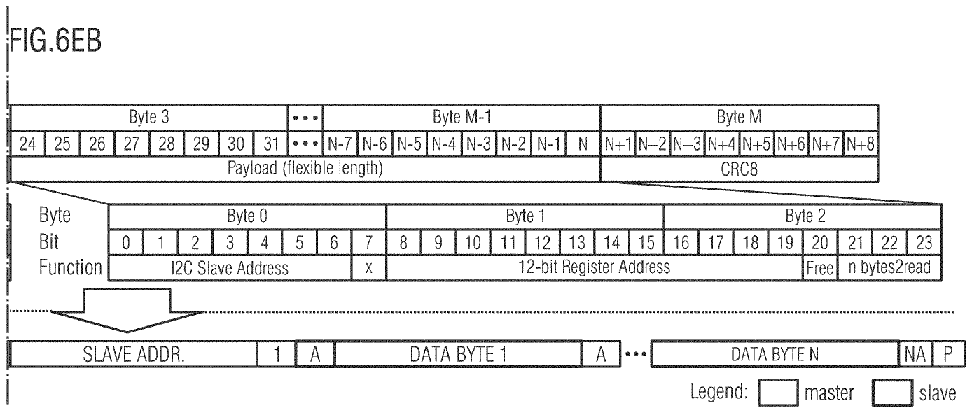

In general, each network node 102 may have a corresponding address associated therewith. The “address” of a node 102 may be a unique identifier of that node 102, and may allow delivering messages to that node 102. Illustratively, a message propagating along the chain of nodes 102 may include an address field (see also FIG. 6A to FIG. 6E) including the address of the node 102 to which the message is addressed. Upon receiving a message, a node 102 may compare the address field of the message with its own address, and either execute an instruction contained in the message if the message is addressed for that node 102, or further propagate the message along the chain if the message is addressed to another node 102.

According to various aspects, each network node 102 may be aware of its respective position within the sequence of network nodes 102. With reference to the secondary nodes 106a-106d, the secondary node 106a connected with the primary node 104 may be the initial node of the sequence of secondary nodes, the secondary node 106d may be the final node of the sequence of secondary nodes (illustratively, an end-of-line, EOL, node), and the other secondary nodes 106b, 106c may be intermediate nodes between the initial node and the final node. Each secondary node 106a-106d may be aware of where the node is located within the sequence, e.g. at position one, two, three, etc. until the final position.

According to various aspects, neighboring network nodes 102 may be connected to one another via a wired connection 110. In this regard, the term “neighboring” or “adjacent” may be used to describe network nodes 102 at consecutive positions within the sequence of network nodes 102, illustratively logically adjacent network nodes 102, without implying a spatial relationship between the network nodes 102. In this framework, considering a certain node 102 as reference point, the term “next” or “subsequent” may be used to describe a further node 102 that is adjacent to the reference node, and is positioned downstream along the chain with respect to a direction of the data transfer. Thus, a message may propagate from the reference node to the next node, and then to a further next node and so on. In a corresponding manner, the term “previous” or “preceding” may be used to describe a further node 102 that is adjacent to the reference node, and is positioned upstream along the chain with respect to a direction of the data transfer. Thus, data may propagate from the preceding node to the reference node.

The wired connection 110 may include one or more wires that electrically conductively connect one network node 102 with the neighboring network node(s) 102. Illustratively, a wired connection 110 may include one or more electrically conductive lines (e.g., electrically conductive wires, or electrically conductive traces). The wired connection 110 may illustratively be a serial bus to which the network nodes 102 are connected forming a chain. The number of electrically conductive lines of a wired connection 110 may be adapted according to the communication protocol via which the network nodes 102 communicate. In a preferred configuration, a wired connection 110 between neighboring nodes 102 may include exactly two electrically conductive lines. A configuration with two electrically conductive lines may allow implementing the OSP protocol, and may thus be particularly suitable for data transfer in a daisy chain network 100. It is however understood that in general a wired connection 110 may include any suitable number of electrically conductive lines, e.g. one, two, three, four, etc. In some aspects, a wired connection 110 may include at maximum four electrically conductive lines.

According to various aspects, the network nodes 102 may be configured to communicate with one another according to a wired communication protocol for serial communication (referred to herein as first communication protocol, or as base communication protocol). Illustratively, the network nodes 102 may be configured to transfer data along the chain of nodes according to rules and parameters defined by the first communication protocol.

As mentioned, in a preferred configuration the network nodes 102 may be configured to communicate with one another according to the Open System Protocol, as this particular protocol may enable a robust communication in daisy chain networks, and may facilitate the configuration of a bridge node, as discussed in further detail below. It is however understood that the aspects described herein may broadly apply to a configuration in which the network nodes 102 communicate according to another type of wired communication protocol for serial communication.

In general, the details of the Open System Protocol are known in the art. An abridged overview is provided herein to introduce aspects relevant for the present disclosure. The OSP protocol may include a layer architecture with five layers, namely an application software layer, an application specific protocol layer, a network layer, a data link layer (DLL), and a physical (PHY) layer. The network layer may define commands conventions for interpreting the data. The DLL may describe the frame format and the encoding of messages according to the OSP protocol. The PHY layer may govern the actual transmission over the physical medium (illustratively, communication via the wired connection).

The OSP protocol may include 3 modes of communication, namely a low-voltage differential signaling mode (LVDS mode); an end of line (EOL) mode or microcontroller (MCU) mode; and a USE mode. Considering the configuration in which the nodes 102 communicate according to the OSP protocol, the aspects of the present disclosure may apply to each of the possible communication modes. In the OSP protocol communication is message based, and a message may have a frame format. The frame may include different fields, namely a preamble, an address, a payload size indicator (PSI), a command, a payload, and a cyclic redundancy check (CRC). The fields of the frame may have different lengths (expressed in bits), and the message length may be variable (e.g., up to 12 bytes). For example, the preamble may be 4 bit long. The address may be 10 bit long and may indicate the address of the target node to which the message is addressed. The PSI may be 3 bit long and may indicate the length of the payload in bytes. The command may be 7 bit long, and commands may be device specific. The payload may have variable length in a range from 0 to 64 bit, as indicated by the PSI. The CRC may be 8 bit long and may include a checksum calculated over the full message excluding the CRC field. A message “field” may also be referred to herein as message “portion”.

According to the OSP protocol the primary node is able to identify the device type of each node in the chain. In this regard, each node may have a respective read-only identification code (e.g., 32 bit long). The read-only identification code may include information representing the node/device, such as device type (e.g., light emitting circuit, sensor, etc.), manufacturer, part identification, and part revision.

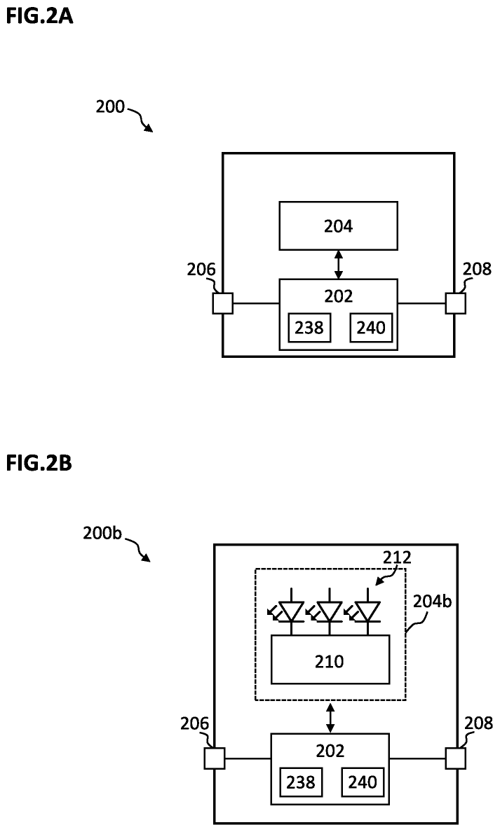

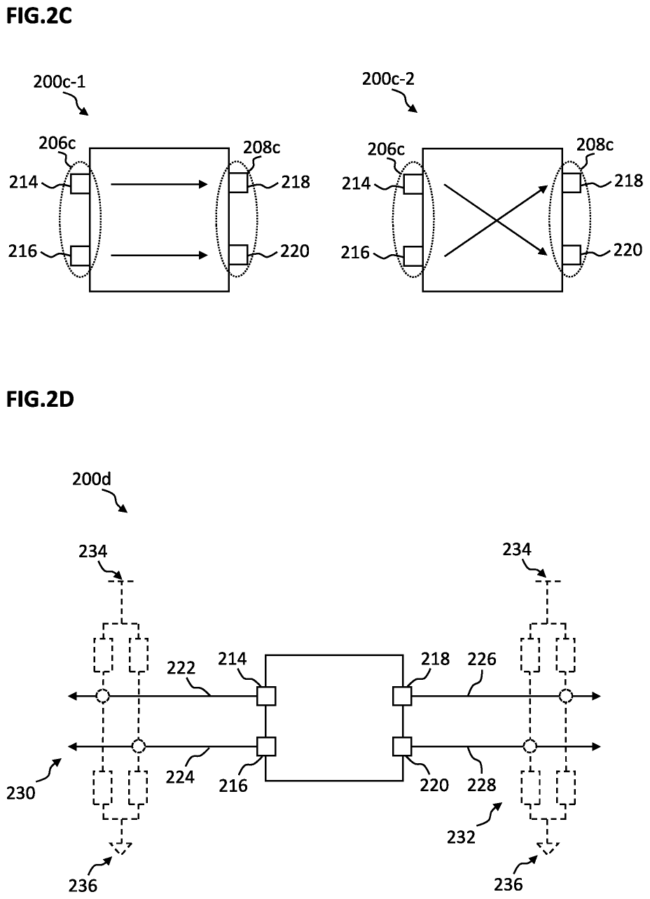

FIG. 2A shows a network node 200 in a schematic representation, according to various aspects. Illustratively, FIG. 2A shows an electronic device configured for use as network node in a serial communication network. The network node 200 may thus be a configuration of a network node 102 of the serial communication network 100 (e.g., a secondary node 106a-106d). It is understood that the representation of the network node 200 may be simplified for the purpose of illustration, and the network node 200 (electronic device) may include additional components with respect to those shown. An “electronic device” may also be referred to herein as electronic module.

In general, the network node 200 may include communication circuitry 202 configured to enable a communicative coupling of the network node 200 with a further electronic device (illustratively, with a further network node). The communication circuitry 202 may be configured to control a voltage level at the wired connection between the network node 200 and the further network node to encode data in the modulation of the voltage level. The communication circuitry 202 may include communication hardware 238 and a processor 240. The processor 240 may be configured to control the communication hardware 238 to implement the communication at the physical level, e.g. to control/define the voltage level at the wired connection. The processor 240 may be further configured to interpret (e.g., decode) messages received at the network node 200, and to generate corresponding response messages to be transmitted using the communication hardware 238. References herein to a configuration of the communication circuitry 202 of a network node 200 may correspondingly refer to a configuration of the communication hardware 238 (at a physical level) and/or processor 240 (at a logical level), as appropriate. As an exemplary realization the processor 240 may be a microprocessor.

In some aspects, a first voltage level at the wired connection (e.g., a high voltage level) may be associated with a logic “1”, and a second voltage level at the wired connection (e.g., a low voltage level) may be associated with a logic “0.” It is however understood that the definition of logic “1” and logic “0” and of the type of signal modulation associated thereto may be arbitrary (e.g., other examples of modulation may include the signal amplitude, the signal frequency, the signal period, etc.). A high voltage level may be understood as a signal having a voltage above a voltage threshold. A low voltage level may be understood as a signal having a voltage below a voltage threshold. Only as a numerical example, a high voltage level may be 1 V and a low voltage level may be 0 V. Considering a configuration according to the OSP protocol the network node 200 may support 3.3 V and 5 V logic levels.

As an exemplary realization, the communication circuitry 202 may include (as part of the communication hardware 238) one or more switch elements (e.g., one or more transistors) to selectively connect or disconnect an electrically conductive path between the wired connection and ground, and/or to selectively connect or disconnect an electrically conductive path between the wired connection and a supply voltage. The processor 240 may be configured to control the one or more switch elements to define the voltage level at the wired connection.

According to various aspects, the network node 200 may include a plurality of input/output ports 206, 208, and the communication circuitry 202 may be coupled with the input/output ports 206, 208. In operation, the network node 200 may receive data via a first input/output port 206, 208 and output data via a second input/output port 206, 208. The propagation direction of the data may vary depending on the configuration of the daisy chain network and depending on the node to which the data are addressed. Illustratively, each input/output port 206, 208 may be configured for coupling with a wired connection (e.g., with one or more electrically conductive lines), and the communication circuitry 202 may be coupled with the wired connection through the input/output port 206, 208. An exemplary configuration for the input/output ports 206, 208 will be described in FIG. 2C.

The network node 200 may further include functional circuitry 204 configured to implement a primary function of the network node 200. Illustratively, the network node 200 may in general be designed to carry out a certain operation, and the communication circuitry 202 may allow interconnecting the network node 200 with other network nodes to exploit its operation in cooperation with the other devices.

The functional circuitry 204 may have any suitable configuration and include any suitable components depending on the intended use of the network node 200. In a preferred configuration, as shown in FIG. 2B, a network node 200b may include (as functional circuitry 204b) light emitting circuitry, e.g. a driver circuit 210 and one or more light emitting elements 212. The driver circuit 210 may be configured to control a light emission by the one or more light emitting elements 212.

In principle, the light emitting elements 212 may be of any suitable type. Considering the context of integrated circuits, the light emitting elements may be or include light emitting diodes (LEDs), e.g. the one or more light emitting elements 212 may include at least one light emitting diode. As another example, the light emitting elements 212 may be or include laser diodes, e.g. edge emitting laser diodes or vertical cavity surface emitting laser diodes.

The light emitting elements 212 (e.g., the LEDs) may be configured to emit light having a predefined wavelength, for example in the visible range (e.g., from about 380 nm to about 700 nm), infrared and/or near-infrared range (e.g., in the range from about 700 nm to about 5000 nm), or ultraviolet range (e.g., from about 100 nm to about 400 nm). In some aspects, the light emitting elements 212 may be configured to emit light in different wavelength ranges. For example a first light emitting element 212 may be configured to emit light in a first wavelength range (e.g., a first color, for example blue), a second light emitting element 212 may be configured to emit light in a second wavelength range (e.g., a second color, for example red), and a third light emitting element 212 may be configured to emit light in a third wavelength range (e.g., a third color, for example green), etc.

It is understood that in other aspects an electronic device for use as a node in a daisy chain network may include a different type of functional circuitry 204. As another example, the network node 200 may include (as functional circuitry 204) a sensor circuit configured to sense a physical quantity, e.g. temperature, humidity, light, vibrations, etc. It is also understood that the functional circuitry 204 (e.g., the light emitting elements 212) may be integrated within the network node 200 or, in other aspects, the network node 200 may be configured to be coupled with functional circuitry 204 disposed externally to the network node 200. Illustratively, in this other scenario the network node 200 may include one or more terminals configured to allow a coupling of the network node 200 with the functional circuitry 204 (e.g., the light emitting elements 212) that is externally coupled with the network node 200. For example, the network node 200 may include circuitry configured to drive the external functional circuitry, e.g., a driving circuit for driving light emission by the externally connected light emitting elements 212.

The functional circuitry 204 may be communicatively coupled with the communication circuitry 202. The communication circuitry 202 (e.g., the processor 240) may thus be configured to deliver instructions to the functional circuitry 204 (received from the primary node of the network) and/or to receive information from the functional circuitry 204. For example, the communication circuitry 202 may receive status information from the functional circuitry 204, e.g. representative of operating parameters, of a current operation status (e.g., active, idle), the result of a sensing process, and the like.

According to various aspects, the network node 200 may further include a memory (not shown). The memory may be configured to store data and instructions for an operation of the network node 200. For example, the memory may be configured to store communication parameters for the communication circuitry 202 to carry out the communication via the wired connection. As another example, the memory may be configured to store instructions for operating the functional circuitry 204.

FIG. 2C shows exemplary configurations for the input/output ports 206c, 208c of the network node 200. According to various aspects, the network node 200 may include two identical input/output ports 206c, 208c, each including two input/output pins 214, 216, 218, 220. This configuration may be provided for communication according to the OSP protocol. It is however understood that in other aspects the input/output ports 206, 208 of the network node 200 may have a different configuration depending on the specific communication protocol used.

Two configurations may be provided. A first configuration 200c-1 may provide a symmetric alignment, in which a first input/output pin 214 of the first input/output port 206c may be coupled with a corresponding first input/output pin 218 of the second input/output port 208c, and a second input/output pin 216 of the first input/output port 206c may be coupled with a corresponding second input/output pin 220 of the second input/output port 208c. Considering the OSP protocol, the symmetric configuration may be provided, for example, when inter-node connectivity is realized via LVDS.

A second configuration 200c-2 may provide a crossed alignment, in which the first input/output pin 214 of the first input/output port 206c may be coupled with the second input/output pin 220 of the second input/output port 208c, and the second input/output pin 216 of the first input/output port 206c may be coupled with the first input/output pin 218 of the second input/output port 208c. Considering the OSP protocol, the crossed configuration may be provided, for example, when inter-node connectivity is realized via USE mode.

FIG. 2D shows an exemplary configuration for connecting the network node 200d to electrically conductive lines 222, 224, 226, 228. As shown, the first input/output pin 214 of the first input/output port may be connected to a first electrically conductive line 222, the second input/output pin 216 of the first input/output port may be connected to a second electrically conductive line 224, the first input/output pin 218 of the second input/output port may be connected to a third electrically conductive line 226, and the second input/output pin 220 of the second input/output port may be connected to a fourth electrically conductive line 228.

The electrically conductive lines 222, 224, 226, 228 associated with each of the pins 214, 216, 218, 220 may be connected to a pullup resistor or a pulldown resistor, such as depicted in 230, wherein the first transmission line 222 is connected to a pull-up resistor and the second transmission line 224 is connected to a pulldown resistor, and in 232 wherein the third transmission line 226 is connected to a pull-up resistor and the fourth transmission line 228 is connected to a pulldown resistor. Naturally, this configuration is given for demonstrative purposes, and the polarities of the pins and corresponding lines may be reversed as desired for a given implementation. The resistance of the various pull-up resistors and pulldown resistors depends at least on the type of signal encoding used, the magnitude of the supply voltage, and the range of voltage used for signal transmission. Only as a numerical example the pull-up resistors and pulldown resistors may each be approximately 10 kΩ. The resistors may couple the electrically conductive lines 222, 224, 226, 228 with a supply voltage 234 (illustratively, with a supply terminal configured to be coupled with a supply source) and/or with ground 236 (illustratively, a ground terminal), thus enabling a modulation of the voltage level at the electrically conductive lines 222, 224, 226, 228.

As mentioned above, aspects of the present disclosure may be based on the realization that in modern systems it is desirable to provide a flexible and efficient communication between different types of devices or between different portions of a system dedicated to different functionalities. Thus, aspects of the present disclosure may be based on the realization that in a daisy chain network of serially communicating nodes configuring (any) one of the nodes as “bridge node” to provide an interface with external devices may allow the daisy chain network to easily communicate with third party devices, thus facilitating the integration of the daisy chain network in a system in which multiple functionalities should be provided. The bridge node allows thus a customer to interact with a generic serial bus using a generic protocol, e.g. allows a customer to interact with an OSP bus.

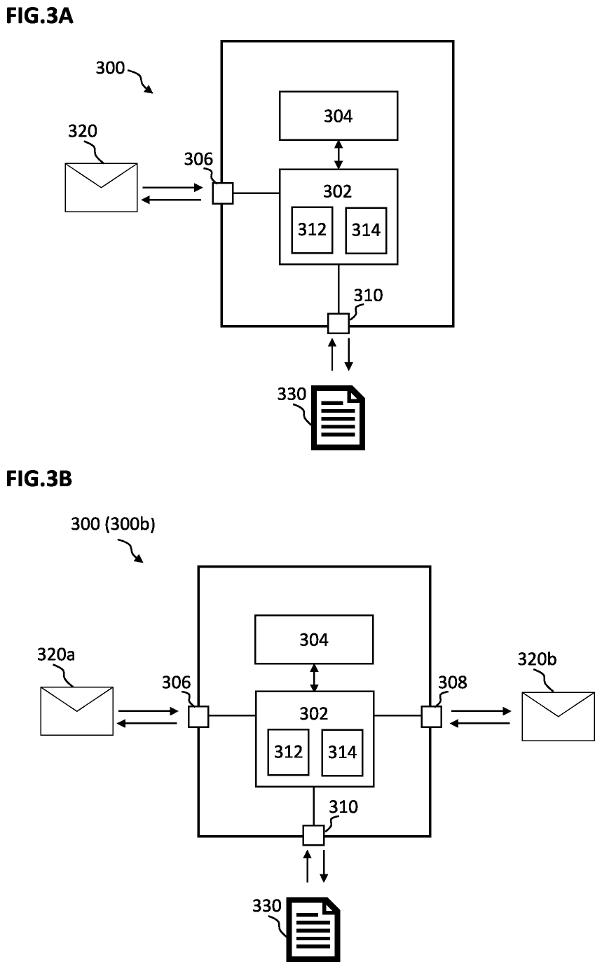

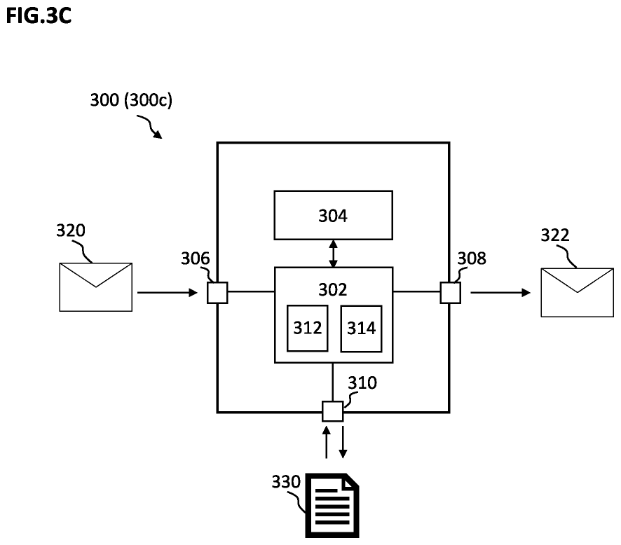

FIG. 3A to FIG. 3C show a network node configured to act as a bridge node 300 in a schematic representation, according to various aspects. Illustratively, FIG. 3A to FIG. 3C show an electronic device configured for use as bridge node 300 in a serial communication network. The bridge node 300 may thus be a configuration of a network node 102 of the serial communication network 100, e.g. of any one of the secondary nodes (the initial node, the final node, or any one of the intermediate nodes). It is understood that the representation of the bridge node 300 may be simplified for the purpose of illustration, and the bridge node 300 may include additional components with respect to those shown. The bridge node 300 may also be referred to herein as bridge device.

In general, the aspects described in relation to the network node 200 in FIG. 2A to FIG. 2D may apply in a corresponding manner to the bridge node 300. In brief, the bridge node 300 may include communication circuitry 302, functional circuitry 304, and input/output ports 306, 308. In some aspects, the bridge node 300 may be a dedicated node in the daisy chain network, so that the bridge node 300 may be free of the functional circuitry 304, or may include a different circuitry with respect to the other network nodes. In other aspects, the bridge node 300 may have the same primary function as the other network nodes, e.g. the bridge node 300 may include functional circuitry 304 configured as the functional circuitry of the other network nodes. For example, the functional circuitry 304 may include a driver circuit and one or more light emitting elements, as discussed in relation to FIG. 2B.

As a difference with respect to a “simple” network node (e.g., the network node 200), the communication circuitry 302 of the bridge node 300 may be configured to enable communication according to two different communication protocols. The communication circuitry 302 may thus be configured to enable a communicative coupling of the bridge node 300 with at least one other network node (or two network nodes, as shown in FIG. 3B and FIG. 3C) and further with an external device that is not part of the daisy chain network.

The communication circuitry 302 may thus be configured to enable a first communication according to the first communication protocol used in the daisy chain network (e.g., OSP), and further to enable a second communication according to a second communication protocol used by the external device. By way of illustration, the external device may be configured to communicate according to a (second) communication protocol different from the (first) communication protocol used in the daisy chain network. The second communication protocol may be another communication protocol for wired communication, e.g. another serial communication protocol for wired communication or a protocol for wired communication that supports parallel data transfer. The second communication protocol may also be referred to herein as external communication protocol.

The communication circuitry 302 may illustratively include a first circuit portion 312 configured to carry out a first communication according to the first communication protocol with the network node(s) of the daisy chain network with which the bridge node 300 is connected. The communication circuitry 302 may further include a second circuit portion 314 configured to carry out a second communication according to the second communication protocol with the external device with which the bridge node 300 is connected.

The first circuit portion 312 may thus include one or more components to control or define a voltage level at an input/output port 306 (e.g., at one or more electrically conductive lines, e.g. as described in FIG. 2D) at which the bridge node 300 is or will be coupled with another network node. The second circuit portion 314 may include one or more components to control or define a voltage level at an input/output port 308 (e.g., at one or more electrically conductive lines) at which the bridge node 300 is or will be coupled with the external device.

The specific configuration of the first and second circuit portions 312, 314 and of the input/ports 306, 308 may be adapted depending on the communication protocols between which the bridge node 300 should provide the bridging functionality. In this regard, a number of pins, a type and/or number of resistors, a type and/or number of switch elements, etc. may be adapted depending on the first and second communication protocols. Considering OSP protocol, as discussed in relation to FIG. 2C, the input/output port 306 for coupling with another network node may include two input/output pins for coupling with two electrically conductive lines.

In some aspects, the hardware of the circuit portions 312, 314 may be specific for the communication protocols between which the bridge node 300 should provide the bridging functionality. Illustratively, the first circuit portion 312 may include hardware components that enable communication using the first communication protocol, and the second circuit portion 314 may include hardware components that enable communication using the second communication protocol.

Broadly speaking, the communication circuitry 302 of the bridge node 300 (e.g., a processor of the communication circuitry 302) may be configured to provide a bridging interface between the two different communication protocols, thus acting as an “interpreter” or “translator” between the daisy chain network and the external device. The bridge node 300 may thus allow third party devices to be coupled with the daisy chain network without the need for the third party devices to know how to communicate according to the (first) communication protocol of the daisy chain network. The processor of the communication circuitry 302 may control the hardware components of the first circuit portion 312 and of the second circuit portion 314 to enable a communication according to the first and second communication protocols, respectively.

In this regard, the communication circuitry 302 (e.g., a processor of the communication circuitry 302) may be configured to receive a first message 320 configured according to the first communication protocol (e.g., an OSP telegram), and transform the first message 320 into a second message 330 configured according to the second communication protocol. The communication circuitry 302 may receive the first message 320 from the daisy chain network, illustratively from the network node with which the bridge node is coupled. The communication circuitry 302 may transmit the transformed message 330 to the external device.

Considering a bidirectional communication also the opposite scenario may occur. The communication circuitry 302 may thus be configured to receive the second message 330 configured according to the second communication protocol, and transform the second message 330 into a first message 320 configured according to the first communication protocol. In this scenario, the communication circuitry 302 may receive the second message 330 from the external device, and may deliver the transformed message 320 to the connected network node.

The communication circuitry 302 may thus be configured to extract information from the first message 320 and embed the extracted information into the second message 330, illustratively into a structure compatible with the second communication protocol. In a corresponding manner, the communication circuitry 302 may be configured to extract information from the second message 330 and embed the extracted information into the first message 320, illustratively into a structure compatible with the first communication protocol. An exemplary extraction/embedding will be discussed in further detail in relation to FIG. 6A to FIG. 6E.

The communication circuitry 302 (e.g., the first circuit portion 312) may thus be configured to carry out a first communication at the network-side with first communication parameters, such as a first timing (e.g., synchronous or asynchronous), a first encoding, first voltage levels to define logic levels, a first message structure, a first data rate, etc. The circuitry 302 (e.g., the second circuit portion 314) may further be configured to carry out a second communication at the external device-side with second communication parameters, such as a second timing, a second encoding, second voltage levels to define logic levels, a second message structure, a second data rate, etc. One or more of the first communication parameters may be different from the corresponding second communication parameters.

The communication circuitry 302 may thus be configured to translate the (first) physical layer of the first communication protocol into the (second) physical layer of the second communication protocol and vice versa. Illustratively, the first circuit portion 312 may be configured to communicate using the first physical layer and the second circuit portion 314 may be configured to communicate using the second physical layer. The first physical layer may differ from the second physical layer in one or more layer parameters, such as number of electrically conductive lines, type of electrically conductive lines, the layout of input/output pins, the voltages, and the like.

The communication circuitry 302 may further be configured to act as a “buffer element” to bridge differences in communication parameters between the two protocols. Illustratively, the communication circuitry 302 may be configured to compensate a difference in one or more communication parameters (e.g., transmission rate and/or latency) between the first communication protocol and the second communication protocol. For example, the communication circuitry 302 may communicate at the network-side with a first data rate and at the external device-side with a second data rate. The communication circuitry 302 may thus transmit (first) messages towards the connected network node at the first data rate and (second) messages towards the external device at the second data rate.

Illustratively, the bridge node 300 may receive a message from either side (e.g., the first message 320 or second message 330) and may store the received message in an internal buffer before forwarding it (e.g., towards the connected network node, or to the external device). This may enables connecting two busses with incompatible bit rates, for example. Also, the “buffering” may allow the bridge node 300 to receive data from the external device without explicit request, for instance caused by an interrupt indicating that a measurement has been finished, which can then be read by the primary node at a later time (from the buffer of the bridge node 300).

In principle, the strategy proposed herein may be adapted to any suitable “second” communication protocol, e.g. any suitable wired communication protocol other than the one used in the daisy chain network. The “second” communication protocol may be a wired communication protocol for serial communication and/or parallel communication. In a preferred configuration, the second communication protocol may be the I²C protocol, as this may be a typical protocol used for sensors, which are a relevant component in combination with daisy chains of lighting devices to implement advanced functionalities, e.g. in a vehicle. It is however understood that in other aspects the second communication protocol may be another type of wired communication protocol.

In principle, the bridge node 300 may be configured for bidirectional communication or unidirectional communication within the daisy chain network, e.g. depending on the network topology (“linear” or “ring”), and on the position of the bridge node within the network.

As a first exemplary configuration, as shown in FIG. 3A, the bridge node 300 may be configured for bidirectional communication at the network-side and at the external device-side. In this configuration, the first circuit portion 312 may be configured to carry out bidirectional communication with the connected network node at the first input/output port 306, and the second circuit portion 314 may be configured to carry out bidirectional communication with the external device at the second input/output port 310. This configuration with exactly two input/output ports may be provided, for example, in case the bridge node 300 is the last node of the daisy chain, and the daisy chain has a “linear configuration”.

As a second exemplary configuration 300b, as shown in FIG. 3B, the bridge node 300b may be configured for bidirectional communication at the network-side with two network nodes (a preceding node and a next node). In this configuration, the first circuit portion 312 may be configured to carry out bidirectional communication with connected network nodes at the first input/output port 306 and at a further (third) input/output port 308. As in the first configuration, the second circuit portion 314 may be configured to carry out bidirectional communication with the external device at the second input/output port 310. The bridge node 300b may thus receive first messages 320a, 320b configured according to the first communication protocol via either of the first input/output port 306 and/or third input/output port 308, and may deliver transformed messages to either of the first input/output port 306 and/or third input/output port 308. This configuration may be provided, for example, in case the bridge node 300b is the first node or an intermediate node of a linear daisy chain.

As a third exemplary configuration 300c, as shown in FIG. 3C, the bridge node 300c may be configured for unidirectional communication at the network-side with two network nodes (a preceding node and a next node). In this configuration, the first circuit portion 312 may be configured to carry out unidirectional communication with connected network nodes at the first input/output port 306 and at the third input/output port 308. As in the first and second configuration, the second circuit portion 314 may be configured to carry out bidirectional communication with the external device at the second input/output port 310. This configuration may be provided, for example, in case the bridge node 300c is any secondary node in a ring daisy chain.

According to various aspects, the bridge node 300 may further include a memory (not shown). The memory may provide a buffer to store data from the external device to be retrieved by the primary node of the daisy chain network at a later time point, e.g. to enable non-blocking read operations (e.g., start conversion, wait . . . , read result). In this scenario, the communication circuitry 302 may be further configured to extract information (data) from the second message 330 and cause a storing of the extracted data in the memory. Only as an example, the extracted data may represent the result of a sensing process (e.g., the value of a sensed physical quantity).

Upon receiving a corresponding instruction from the primary node, the communication circuitry 302 may be further configured to retrieve the stored data, embed the retrieved data into a first message according to the first communication protocol, and cause a transmission of the first message to the primary node of the daisy chain network.

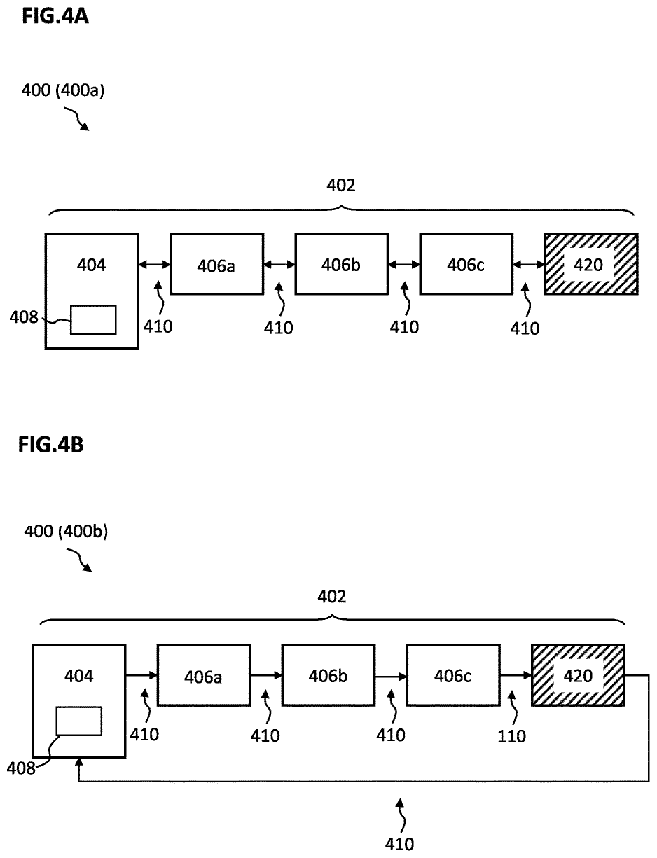

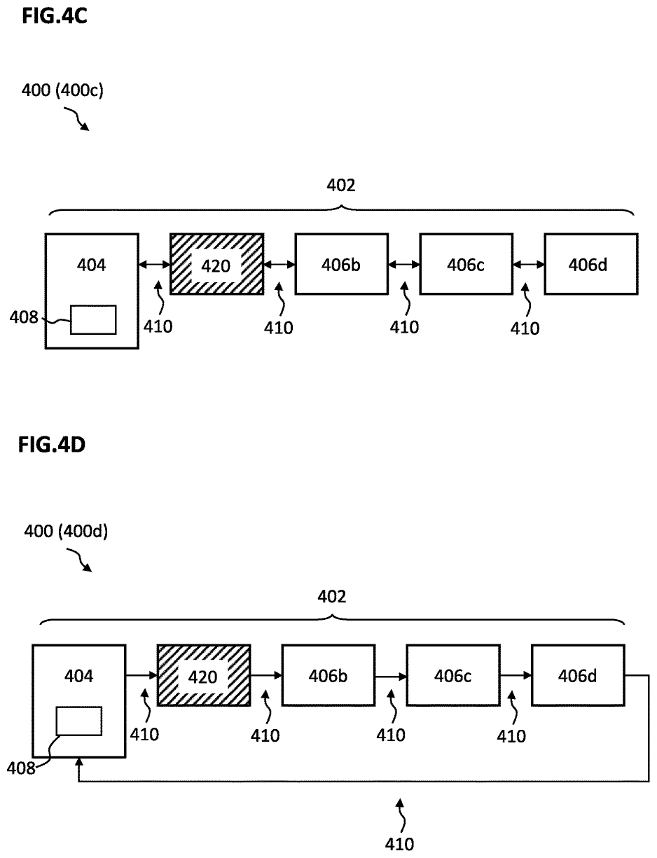

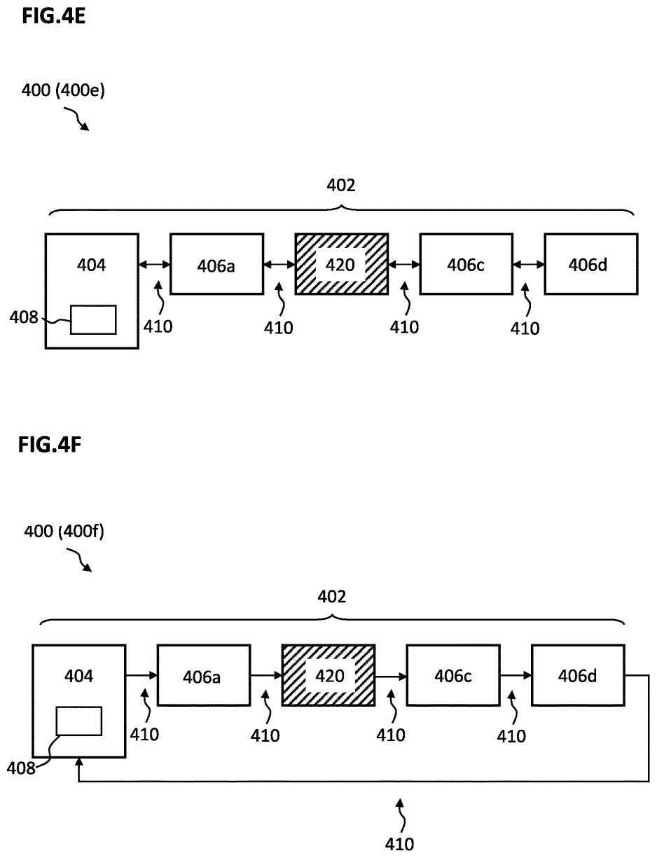

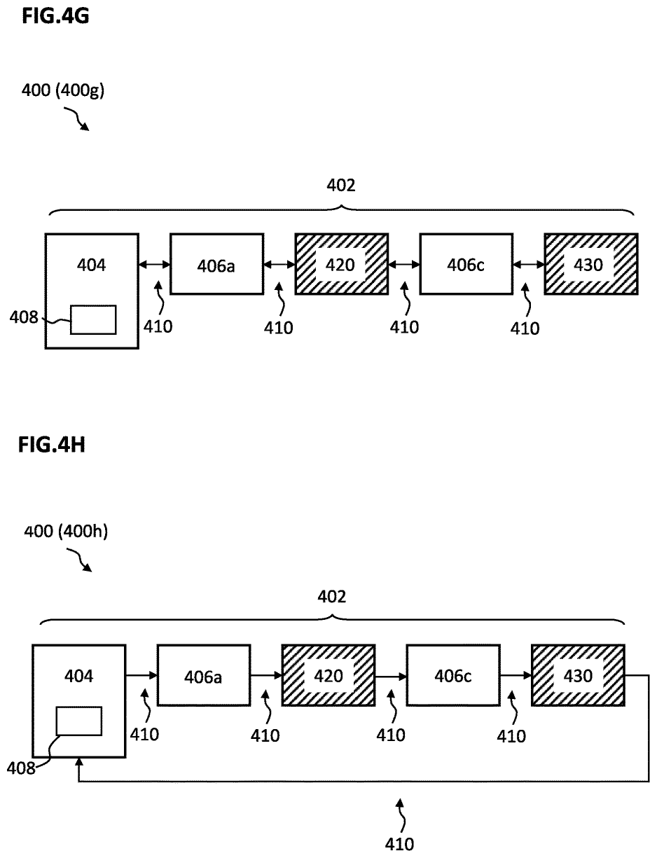

FIG. 4A to FIG. 4H show possible dispositions of a bridge node 420, 430 within a serial communication network 400, in a schematic representation, according to various aspects. The serial communication network 400 may be configured as the serial communication network 100 described in relation to FIG. 1A and FIG. 1, and may include a plurality of network nodes 402 with a primary node 404 and one or more secondary nodes 406a-406d, e.g. a plurality of secondary nodes 406a-406d. The network nodes 402 may be disposed in a daisy chain configuration and may be connected to one another via a wired connection 410. The primary node 404 may include control circuitry 408 to control a communication over the network 400, as discussed above.

The network nodes 402 may in general be configured as the network node 200 described in relation to FIG. 2A to FIG. 2D. For example, at least one secondary node 406a-406d may include light emitting circuitry (e.g., a driver circuit and one or more light emitting elements), for example a subset of secondary nodes 406a-406d may each include light emitting circuitry, for example each secondary node 406a-406d may include light emitting circuitry.

According to various aspects, the daisy chain network 400 may include at least one node configured as bridge node 420 (e.g., configured as described for the bridge node 300 in relation to FIG. 3A to FIG. 3C). FIG. 4A to FIG. 4F show that the bridge node 420 may be disposed at any position within the chain of secondary nodes.

As an example, as shown for a first configuration 400a, 400b in FIG. 4A and FIG. 4B the bridge node 420 may be the last node of the chain. Illustratively, in this configuration the bridge node 420 may be the secondary node that is logically farthest away from the primary node 404. In a linear daisy chain configuration 400a, the bridge node 420 may be connected only to a secondary node 406c. In a ring daisy chain configuration 400b, the bridge node 420 may be connected to a secondary node 406c and further may be connected back with the primary node 404.

As another example, as shown for a second configuration 400c, 400d in FIG. 4C and FIG. 4D the bridge node 420 may be the initial node of the chain. Illustratively, in this configuration the bridge node 420 may be the secondary node that is logically closest to the primary node 404. In this case, both for a linear daisy chain configuration 400a and a ring daisy chain configuration 400b, the bridge node 420 may be connected thus to the primary node 404 and to a secondary node 406b.

As a further example, as shown for a third configuration 400e, 400f in FIG. 4E and FIG. 4F the bridge node 420 may be an intermediate node of the chain. Illustratively, in this configuration the bridge node 420 may be a secondary node that is between the initial secondary node 406a and final secondary node 406d. In this case, both for a linear daisy chain configuration 400a and a ring daisy chain configuration 400b, the bridge node 420 may be connected to two other secondary nodes 406a, 406c.

According to various aspects, the serial communication network 400 may include more than one bridge node, as shown for a fourth configuration 400g, 400h in FIG. 4G and FIG. 4H. In this scenario the serial communication network 400 may include a plurality of bridge nodes, e.g. a first bridge node 420 and a second bridge node 430. It is understood that in principle the serial communication network 400 may include any suitable number of network nodes adapted to act as bridge nodes (by suitably configuring the respective communication circuitry), e.g. two, three, four, five, ten, or more than ten.

In a corresponding manner as in the case with a single bridge node, the plurality of bridge nodes 420, 430 may be disposed at any suitable position within the chain of network nodes 402. For example the first bridge node 420 may be the initial node, and the second bridge node 430 may be the final node. As another example, the first bridge node 420 may be the initial node or the final node, and the second bridge node 430 may be an intermediate node. As a further example, the first bridge node 420 and the second bridge node 430 may be two intermediate nodes.

In various aspects, the bridge nodes 420, 430 may have the same configuration, e.g. each bridge node 420, 430 may be configured to provide a bridging functionality between the (first) wired communication protocol of the daisy chain network 400 and the same (second) wired communication protocol of external devices. In this scenario, the bridge nodes 420, 430 may provide multiple “access points” for coupling the daisy chain network 400 with external devices that use the (same) second wired communication protocol (e.g., I²C). In this configuration, the communication circuitry of bridge node 420, 430 may be configured to receive first messages according to the first communication protocol and transform the first messages into second messages according to the second communication protocol, and vice versa.

In other aspects, different bridge nodes 420, 430 may be dedicated to provide a bridging functionality for different wired communication protocols. In this scenario, the first bridge node 420 (or a first subset of bridge nodes) may be configured to provide a bridge between the (first) wired communication protocol of the daisy chain network 400 and the second wired communication protocol. The second bridge node 430 (or a second subset of bridge nodes) may be configured to provide a bridge between the (first) wired communication protocol of the daisy chain network 400 and a third wired communication protocol (different from the first and second communication protocols). A third bridge node (or a third subset of bridge nodes) may be configured to provide a bridge between the (first) wired communication protocol of the daisy chain network 400 and a fourth wired communication protocol (different from the first, second, and third communication protocols), etc.

In this configuration, the communication circuitry of the first bridge node(s) 420 may be configured to receive first messages according to the first communication protocol and transform the first messages into second messages according to the second communication protocol, and vice versa. The communication circuitry of the second bridge node(s) 430 may be configured to receive first messages according to the first communication protocol and transform the first messages into third messages according to the third communication protocol, and vice versa. The communication circuitry of the third bridge node(s) may be configured to receive first messages according to the first communication protocol and transform the first messages into fourth messages according to the fourth communication protocol, and vice versa, etc.

A configuration with multiple bridge nodes dedicated to different communication protocols may facilitate the integration of the daisy chain network in different application scenarios, and allows combining the daisy chain network with different third party devices, e.g. from different manufacturers.

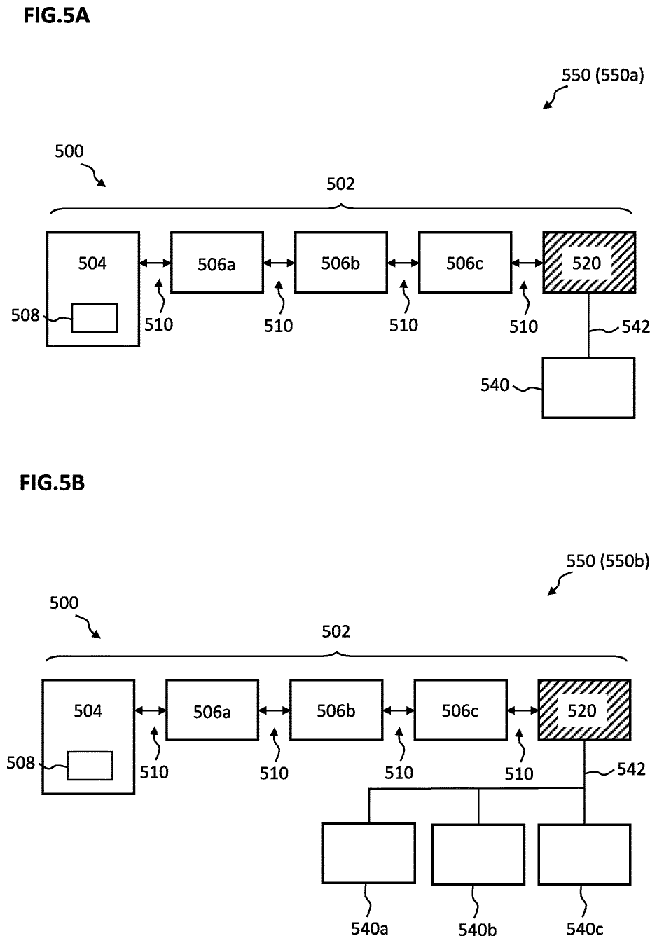

According to various aspects, the control circuitry 408 of the primary node 404 may be further configured to define one or more communication parameters of the bridge node(s) 420, 430. Illustratively, considering the bridge node 420, 430 as a secondary node, the bridge node 420, 430 may be (fully) controlled by the primary node (e.g., by the microcontroller). This interaction will be further described in relation to FIG. 5A and FIG. 5B.

In general, the bridge node(s) 420, 430 may be configured to communicate with the (respective) external device according to the communication parameters defined by the primary node 404. The communication parameters may include, for example, bit rate, number of bits, parity, etc. As an exemplary configuration, a bridge node 420, 430 may include a configuration register accessible from the primary node 404 (e.g., from the control circuitry 408), and the primary node may define communication settings by changing the parameters stored in the configuration register.

Considering as an example a bridge node configured to convert from OSP to I²C (and vice versa), the I²C status register may be an 8-bit register that contains relevant settings for the I²C communication. In general, the I²C communication parameters may be fully device specific. As exemplary settings, the bit 6 may be set to enable the use of devices that require 12-bit addressing via I²C. Bit 5 may be a read-only bit holding the ACK/NACK result from the last I²C operation. When this bit is set, it means that last I²C read or write operation ended with a NACK from the secondary device, indicating an error. A value of 0 means the operation ended with an ACK, indicating a correct read or write operation. Finally, bits [4:0] represent the 5 MSB of a 10-bit division factor used to set the speed of the I²C communication. This value is used to divide the internal oscillator (which is a multiple of 2.4 MHz). For example, a value of 0x00B (0b01011) translates to a division factor of 0b0101100000 (0x160). Assuming an internal oscillator speed of 19.2 MHz, this translates to approximately 54 kHz for the I²C clock.

FIG. 5A and FIG. 5B show a system 550 including a serial communication network 500 with a bridge node 520 and one or more external electronic devices connected to the bridge node 520. The serial communication network 500 may be configured as the serial communication network 100, 400 described in relation to FIG. 1A and FIGS. 1B and 1n relation to FIG. 4A to FIG. 4H, and may include a plurality of network nodes 502 with a primary node 504 and one or more secondary nodes 506a-506c, e.g. a plurality of secondary nodes 506a-506c. The network nodes 502 may be disposed in a daisy chain configuration and may be connected to one another via a wired connection 510. The primary node 504 may include control circuitry 508 to control a communication over the network 500, as discussed above.

The network nodes 502 may in general be configured as the network node 200 described in relation to FIG. 2A to FIG. 2D. For example, at least one secondary node 506a-506c may include light emitting circuitry (e.g., a driver circuit and one or more light emitting elements), for example a subset of secondary nodes 506a-506c may each include light emitting circuitry, for example each secondary node 506a-506c may include light emitting circuitry.

For the purpose of illustration FIG. 5A and FIG. 5B show an exemplary configuration of the network 500, in which the network 500 has a linear daisy chain topology and a single bridge node 520 disposed at the end of the chain. It is however understood that the aspects discussed in relation to the network 500 apply in a corresponding manner to any other suitable configuration discussed in relation to FIG. 4A to FIG. 4H. For example, the aspects discussed in relation to the network 500 apply in a corresponding manner to a network with a ring daisy chain topology, to a network with a bridge node in another position within the chain, to a network with a plurality of bridge nodes, etc.

As shown for a first system configuration 550a in FIG. 5A, the bridge node 520 may be communicatively coupled with an external device 540, illustratively with an electronic device external to the daisy chain network 500. The communicative coupling may include a wired connection 542 between the bridge node 520 (e.g., the second circuit portion of the bridge node, for example at a respective input/output port) and the external device 540. The wired connection 542 may have any suitable configuration depending on the type of (second) communication protocol of the external device 540, e.g. in terms of number of electrically conductive lines, voltage levels, resistors, etc.

In principle, the external device 540 may be any suitable type of electronic device for which it may be relevant to provide a coupling with a daisy chain network (e.g., with a network of light emitting elements). As relevant examples, the external device 540 may be a sensor device, e.g. the external device 540 may include sensing circuitry configured to sense a physical quantity. As another example, the external device 540 may be an actuator device, e.g. the external device 540 may include actuator circuitry configured to cause a physical movement such as a torque, a displacement, and the like. As a further example, the external device 540 may be a memory device, e.g. the external device 540 may include a memory configured to store data. In addition, the external device 540 may include communication circuitry for carrying out wired-based communication with the bridge node 520.

In other aspects, as shown for a second system configuration 550b in FIG. 5B, the bridge node 520 may be communicatively coupled with a plurality of external devices 540a, 540b, 540c external to the daisy chain network 500. In this scenario, the wired connection 542 may provide an electrically conductive coupling between the bridge node and each of the external devices 540a, 540b, 540c. The external devices 540a, 540b, 540c may be arranged in any suitable manner, e.g. may be coupled in parallel to one another, or in series with one another, as examples. In some aspects, the external devices 540a, 540b, 540c may form themselves a communication network, e.g. another daisy chain network. The external devices 540a, 540b, 540c may also be referred to herein collectively as external devices 540.

As mentioned above, the presence of the bridge node 520 allows the primary node 504 of the daisy chain network 500 to interact with the external device(s) 540. Considering the primary-secondary relationship, the primary node 504 may in general control the communication between the bridge node 520 and the external device(s) 540. In some aspects, the bridge node 520 may convert a first message into a second message (or vice versa) upon receiving a corresponding prompt from the primary node 504, e.g. a corresponding instruction causing the bridge node 520 to carry out the bridging functionality.

As mentioned, the bridge node 520 may allow using the primary node 504 to further control the operation of the external device(s) 540, thus eliminating the need for further controllers dedicated (only) to the external device(s). In this configuration the external device(s) 540 may thus become additional secondary devices (additional slaves) responding to the instructions of the primary node 504 of the daisy chain network.

For example, the control circuitry 508 of the primary node 504 may be configured to generate a first instruction message configured according to the first communication protocol, and the first instruction message may include instructions directed to the external device 540 (e.g., directed to one of the external devices 540a-540c). The control circuitry 508 may further cause the communication circuitry of the bridge node 520 to embed the instructions into a second instruction message configured according to the second communication protocol and transmit the second instruction message to the external device 540. Illustratively, the network nodes 502 may propagate the first instruction message until it reaches the bridge node 520. The bridge node 520 may realize that the first instruction message is initially addressed to the bridge node 520 (e.g., by comparing an address field of the first instruction message with the own address). The first instruction message may further include initial instructions for the bridge node 520 to prompt the bridge node 520 to convert and deliver the instructions to the external device 540.

The instructions addressed to the external device 540 may prompt any suitable action depending on the type of external device 540. For example, the instructions may prompt the external device 540 to carry out a sensing process and report the result of the sensing process. As another example, the instructions may prompt the external device 540 to carry out an actuation process to cause a physical movement. As a further example, the instructions may prompt the external device 540 to retrieve (and deliver) data from a memory, etc.

In general, the instructions directed to the external device 540 may represent any suitable command, e.g. a read command, a write command, a command to request status information, and the like. In the following, some exemplary instructions are described considering the exemplary case of a OSP daisy chain network and an external device 540 using the I²C protocol. It is understood that such commands are exemplary, and may be adapted depending on the type of external device, on the protocols used, etc.

As an example, the instructions may include an 12C_WRITE command prompting the bridge node 520 to transmit the data in the payload portion of the first instruction message to the external device 540 (I2C slave) as a write message. The PSI value indicates the number of bytes to be transmitted. For example, the bridge node 520 may transmit up to 7 bytes of data (1 byte is needed for the address of the external device 540). Valid data lengths may be 1, 2, 3, 4, 5, and 7 bytes of data.

As another example, the instructions may include an I2C_READxx command, with xx that may be 8, 16, 24, 32, 48, 64, or an I2C_READ command (with length as payload). Such command may request exactly XX bits of data from the external device 540. The bridge node 520 may terminate the read operation after the selected number of bytes has been received. The values of XX match the allowed payload lengths of the OSP. Read data may be stored in a buffer in the bridge node 520 without (immediately) sending a response telegram to the primary node.

As another example, the instructions may include a READ_I2C_CONF command to read the I2C configuration/status register (8 bit), e.g. including I2C data rate, I2C error flag etc. As a further example, the instructions may include a WRITE_I2C_CONF command to write the I2C configuration/status register (8 bit), e.g. including I2C data rate, I2C error flag etc.

As a further example, the instructions may include a READ_LAST_DATA command. Such command may return a telegram with the data last read from the external device 540. The PSI value indicates the number of bytes retrieved. Devices may use only one fixed payload length, e.g., 64-bit, with zero padding.

As a further example, the instructions may include an I2C_START_WRITE command, an I2C_CONTINUE_WRITE command, and/or an I2C_STOP_WRITE command. The I2C_START_WRITE command may tell the bridge node 520 that the data in the payload shall be transmitted to the external device 540 as a write message but do not finish the transaction yet (no stop bit). The PSI value indicates the number of bytes to be transmitted. CLK and DATA are suspended until the next telegram is received. The bridge node 520 may transmit up to 7 bytes of data. This command may be followed by I2C_CONTINUE_WRITE or by I2C_STOP_WRITE.

The I2C_CONTINUE_WRITE command may prompt bridge node 520 to send the data in the payload as is. Payload may only contain data, no slave address. The PSI value indicates the number of bytes to be transmitted. CLK and DATA are suspended until the next telegram is received. The bridge node 520 may transmit up to 8 bytes of data. The I2C_STOP_WRITE command may prompt the bridge node 520 to send the data in the payload as is. Payload may only contain data, no slave address. The bridge ends the transmission with a stop bit to signal the end of the write process. The PSI value indicates the number of bytes to be transmitted. The bridge node 520 may transmit up to 8 bytes of data.

In some aspects, the instructions addressed to the external device 540 may be configured to prompt a response from the external device 540. In this scenario, the communication circuitry of the bridge node 520 may receive a (second) response message from the external device 540. The (second) response message may be configured according to the (second) wired communication protocol of the external device 540, and may include a response to the prompt from the primary device 540 (e.g., a result of a sensing process, a confirmation of the actuation, data from the memory, etc.). The communication circuitry of the bridge node 520 may embed data from the (second) response message representative of the response from the external device 540 into a first response message configured according to the first communication protocol. The communication circuitry of the bridge node 520 may further cause a transmission of the first response message to the primary node 504, e.g. the communication circuitry may initiate a propagation of the first response message from the bridge node 520 to the primary node 504 along the chain of network nodes 502.

In some aspects, the external device 540 may be configured to transmit information to the primary node 504 even in absence of a corresponding prompt from the primary node 504. For example, the external device 540 may carry out a certain process and send corresponding information to the primary node 504 over the bridge node 520. Considering the exemplary case of a sensing device, the sensor may trigger an interrupt and transmit the data to the primary node 504 in an automatic manner.

The communication circuitry of the bridge node 502 may thus receive from the external device 540 a (second) data message configured according to the second communication protocol. The external device 540 may transmit the data message in absence of a corresponding instruction or prompt from the primary node 504. The communication circuitry of the bridge node 502 may embed data from the (second) data message representative of the data from the external device 540 into a first data message configured according to the first communication protocol. The communication circuitry of the bridge node 520 may further cause a transmission of the first data message to the primary node 504.

FIG. 6A to FIG. 6E show the embedding of data from a message according to a first communication protocol into a message according to a second communication protocol, and vice versa, according to various aspects.

In general, the messages may have any suitable structure depending on the type of communication protocols involved. In the following some examples and general considerations are provided, but it is understood that the aspects described herein may be correspondingly adapted to other types of message structures for other types of wired communication protocols.

In this regard, FIG. 6A shows an exemplary configuration for a first message 600 configured according to the (first) communication protocol of the daisy chain network and for a second message 610 configured according to the (second) communication protocol of an external device. The simplified representation in FIG. 6A focuses on the relevant fields that a message may include, but it is understood that a first message 600 or second message 610 may include additional message fields with respect to those shown. Considering the exemplary OSP case, a (first) message may also be referred to as “telegram”.

In general, the first message 600 may have a frame structure including a plurality of message portions or fields 602-606, including at least an address portion 602, a command portion 604, and a data portion 606 (referred to also as “payload portion”). The bit length of each portion may depend on the type of communication protocol.

Considering the bridging operation, the address portion 602 may include the address of the bridge node, such that each other network node in the chain forwards the first message 600 until it reaches the bridge node. Based on the content of the address portion 602, the bridge node may realize that the first message includes information that the bridge node should process.

The command portion 604 may include a command to instruct an operation of the bridge node, e.g. to prompt the bridge node to embed data from the first message 600 into a second message 610, to prompt the bridge node to wait for a response message from the external device, and the like.

The data portion 606 may include data (information) to be delivered to the external device. The bridge node may thus use the data from the data portion 606 (e.g., from the payload portion) to provide the second message 610. Illustratively, the bridge node (e.g., the processor of the communication circuitry) may take the data from the data portion 606 and embed the data in a corresponding structure according to the second communication protocol. The data may include, for example, an address of the external device, and a command to be delivered to the external device.

The second message 610 may include corresponding message portions, e.g. an address portion 612 and a data portion 614. Considering a conversion from the first protocol to the second protocol, the bridge node may embed the content of the data portion 606 of the first message 600 into the address portion 612 and data portion 614 of the second message 610. Considering the opposite scenario with a conversion from the second protocol to the first protocol, the bridge node may embed the content of the data portion 614 of the second message 610 into the data portion 606 of the first message 600.

The bridge node may further adjust the bits of the messages to match the proper format for the communication protocols. For example, the communication circuitry of the bridge node may be further configured to insert or strip overhead bits when embedding data from a first message 600 into a second message 610, or when embedding data from a second message 610 into a first message 600.

FIG. 6B to FIG. 6E illustrate exemplary scenarios of data embedding from a first message configured according to the OSP protocol into a second message configured according to the I²C protocol, and vice versa. The bridge node may thus pack and unpack telegrams for I²C into and from OSP messages. The bridge node may automatically insert or strip the necessary overhead bits for I²C (e.g., START/STOP/ACK).

FIG. 6B shows an exemplary scenario 620 of a write operation with 8-bit addressing for the I²C device. The bridge node may embed the information from the payload portion (or section) of the OSP message into a I²C message including the address of the external device, an 8-bit register address, and data bytes to be written. With 8-bit addressing, the first byte is the address of the external device, the second byte the I²C register address, and up to 6 bytes of data. Valid data lengths may be 1, 2, 3, 4 and 6 bytes of data.

FIG. 6C shows an exemplary scenario 630 of a read operation with 8-bit addressing for the I²C device. The bridge node may embed the information from the payload portion (or section) of the OSP message into an I²C message including the address of the external device, and an 8-bit register address. The bridge node may further embed data bytes from a response I²C message into the payload portion of a response OSP telegram.

FIG. 6D and FIG. 6E show the exemplary scenarios 640, 650 of a write operation with 12-bit addressing and of a read operation with 12-bit addressing. If 12-bit addressing is used, the first byte is the address of the external device, followed by 2 bytes for register address, and the remaining bytes for up to 5 bytes of data. Valid data lengths may be 1, 2, 3, and 4 bytes of data.

The following examples pertain to aspects of the present disclosure.

Example 1 is a serial communication network, including: a plurality of network nodes including a primary node and one or more secondary nodes, wherein the plurality of network nodes are connected in a daisy chain configuration and are configured to communicate with one another according to a first wired communication protocol for serial communication; wherein at least one of the network nodes is configured to act as bridge node, wherein the bridge node comprises communication circuitry configured to: enable a communicative coupling of the bridge node with at least one other network node and with an external device not part of the daisy chain of network nodes, receive from the at least one other network node a first message configured according to the first wired communication protocol, and embed data from the first message into a second message configured according to a second wired communication protocol for transmission to the external device; and/or receive from the external device a second message configured according to the second wired communication protocol, and embed data from the second message into a first message configured according to the first wired communication protocol for transmission to the at least one other network node, wherein the second wired communication protocol is different from the first wired communication protocol.

In Example 2, the serial communication network according to example 1 may optionally further include that the one or more secondary nodes include a plurality of secondary nodes, that the plurality of secondary nodes include an initial secondary node, a final secondary node, and one or more intermediate secondary nodes disposed between the initial secondary node and the final secondary node, and that the bridge node is the initial secondary node, or the final secondary node, or one of the intermediate secondary nodes.

In Example 3, the serial communication network according to example 1 may optionally further include that the first wired communication protocol is the Open System Protocol.

In Example 4, the serial communication network according to any one of examples 1 to 3 may optionally further include that at least one secondary node comprises one or more light emitting elements and a driver circuit for controlling a light emission by the one or more light emitting elements.

In Example 5, the serial communication network according to any one of examples 1 to 4 may optionally further include that the primary node is configured to: generate a first instruction message configured according to the first wired communication protocol, wherein the first instruction message comprises instructions directed to the external device; and cause the communication circuitry of the bridge node (420) to embed the instructions into a second instruction message configured according to the second wired communication protocol and transmit the second instruction message to the external device.

In Example 6, the serial communication network according to example 5 may optionally further include that the instructions of the first instruction message are configured to prompt a response from the external device; and that the communication circuitry of the bridge node is configured to: receive, from the external device, a second response message configured according to the second wired communication protocol; embed a response from the second response message into a first response message configured according to the first wired communication protocol; and cause a transmission of the first response message to the primary node (404).

In Example 7, the serial communication network according to any one of examples 1 to 6 may optionally further include that the bridge node further comprises a memory; and that the communication circuitry of the bridge node is further configured to: receive from the external device a second data message configured according to the second wired communication protocol, extract data from the second data message; and cause a storing of the extracted data in the memory.

In Example 8, the serial communication network according to example 7 may optionally further include that the communication circuitry of the bridge node is further configured to: embed the data stored in the memory into a first data message configured according to the first wired communication protocol; and cause a transmission of the first data message to the primary node.

In Example 9, the serial communication network according to any one of examples 1 to 8 may optionally further include that the communication circuitry of the bridge node is further configured to: receive from the external device a second data message configured according to the second wired communication protocol; embed data from the second data message into a first data message configured according to the first wired communication protocol; and cause a transmission of the first data message to the primary node.

In Example 10, the serial communication network according to any one of examples 1 to 9 may optionally further include that a further network node is configured to act as further bridge node, and that the further bridge node comprises communication circuitry configured to: enable a communicative coupling of the further bridge node with at least one other network node and with a further external device not part of the daisy chain of network nodes, receive from the at least one other network node a first message configured according to the first wired communication protocol, and embed data from the first message into a third message configured according to a third wired communication protocol for transmission to the external device; and/or receive from the external device a third message configured according to the third wired communication protocol, and embed data from the third message into a first message configured according to the first wired communication protocol for transmission to the at least one other network node, wherein the third wired communication protocol is different from the first wired communication protocol and from the second wired communication protocol.

In Example 11, the serial communication network according to any one of examples 1 to 10 may optionally further include that the first message configured according to the first communication protocol has a frame structure comprising a payload portion; and that the communication circuitry of the bridge node is configured to embed information from the second message into the payload portion of the first message.

In Example 12, the serial communication network according to any one of examples 1 to 11 may optionally further include that the second communication protocol is the Inter-Integrated Circuit bus communication protocol.

Example 13 is a system including: the serial communication network according to any one of examples 1 to 12; and the external device communicatively coupled with the bridge node.

In Example 14, the system of example 13 may optionally further include that the external device is one of a sensor device, an actuator device, or a memory device.

Example 15 is an electronic device for use as bridge node in a daisy chain of network nodes, the electronic device including: communication circuitry including a first circuit portion configured to carry out a first communication according to a first wired communication protocol for serial communication, and a second circuit portion configured to carry out a second communication according to a second wired communication protocol, wherein the first wired communication protocol is different from the second wired communication protocol.

The terms “processor” or “control circuitry” as used herein may be understood as any kind of technological entity that allows handling of data. The data may be handled according to one or more specific functions that the processor/control circuitry may execute. Further, a processor/control circuitry as used herein may be understood as any kind of circuit, e.g., any kind of analog or digital circuit. A processor/control circuitry may thus be or include an analog circuit, digital circuit, mixed-signal circuit, logic circuit (e.g., a hard-wired logic circuit or a programmable logic circuit), microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. It is understood that any two (or more) of the processor/control circuitry detailed herein may be realized as a single entity with equivalent functionality or the like, and conversely that any single processor/control circuitry detailed herein may be realized as two (or more) separate entities with equivalent functionality or the like.

The term “connected” may be used herein with respect to terminals, integrated circuit elements, devices, and the like, to mean electrically connected, which may include a direct connection or an indirect connection, wherein an indirect connection may only include additional structures in the current path that do not influence the substantial functioning of the described circuit or device. The term “electrically conductively connected” that is used herein to describe an electrical connection between one or more terminals, devices, regions, contacts, etc., may be understood as an electrically conductive connection with, for example, ohmic behavior, e.g. provided by a metal or degenerate semiconductor in absence of p-n junctions in the current path. The term “coupled” may be used herein in the same manner as the term “connected”.

The term “terminal” may be used herein to describe a location (e.g., a point) or structure of a device or of an element of the device at which a signal (e.g., an analog signal, for example a current or a voltage) may be provided and/or to which another device or element may be connected. Illustratively, a terminal may be a location or a structure that is electrically conductively connected with the device or the element. A terminal may also be referred to herein as port, pin, contact, or contact point.

The terms “path”, “electrical path”, or “electrically conductive path” may be used herein to describe an electrically conductive connection between two or more elements. A path may be understood, in some aspects, as an electrically conductive line (or trace) along which a signal (in some aspects, a current or a voltage) may travel, e.g. from a first element connected to the path to a second element connected to the path or vice versa. The term path may describe a direct path or an indirect path, wherein an indirect path may only include additional structures in the path that do not influence the substantial functioning of the described circuit or device (illustratively, that do not influence the signal traveling along the path).

As used herein, a signal that is “indicative of”, “representative of” or “representing” a value or other information (e.g., an instruction) may be a digital or analog signal that encodes or otherwise communicates the value or other information in a manner that can be decoded by and/or cause a responsive action in a component receiving the signal (e.g., in a secondary device receiving instructions from a primary device, or in a primary device receiving data from a secondary device).

As used herein, “memory” is understood as a computer-readable medium (e.g., a non transitory computer readable medium) in which data or information can be stored for retrieval. References to “memory” included herein may thus be understood as referring to volatile or non volatile memory, including random access memory (RAM), read only memory (ROM), flash memory, solid state storage, magnetic tape, hard disk drive, optical drive, among others, or any combination thereof. Registers, shift registers, processor registers, data buffers, among others, are also embraced herein by the term memory.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

Unless specified otherwise, the term “subset” in relation to a group of elements may be understood to include a numerical quantity equal to or greater than one and less than a total number of the implied elements. Considering for example a group of ten elements, a “subset” of the group may include one, two, three, four, five, six, seven, eight, or nine elements. The term “subset” in relation to a group may thus describe a “proper subset” of the group, so that all the elements of the subset belong to the group, but at least one element of the group does not belong to the subset.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

List of reference signs

| | |
|---|---|
| 100 | Serial communication network |
| 100a | Network topology |
| 100b | Network topology |
| 102 | Network node |
| 104 | Primary node |
| 106a | Secondary node |
| 106b | Secondary node |
| 106c | Secondary node |
| 106d | Secondary node |
| 108 | Control circuitry |
| 110 | Wired connection |
| 200 | Network node |
| 200b | Network node |
| 200c-1 | Network node |
| 200c-2 | Network node |
| 200d | Network node |
| 202 | Communication circuitry |
| 204 | Functional circuitry |
| 204b | Functional circuitry |
| 206 | Input/output port |
| 206c | Input/output port |
| 208 | Input/output port |
| 208c | Input/output port |
| 210 | Driver circuit |
| 212 | Light emitting elements |
| 214 | Input/output pin |
| 216 | Input/output pin |
| 218 | Input/output pin |
| 220 | Input/output pin |
| 222 | Electrically conductive line |
| 224 | Electrically conductive line |
| 226 | Electrically conductive line |
| 228 | Electrically conductive line |
| 230 | Resistor arrangement |
| 232 | Resistor arrangement |
| 234 | Supply terminal |
| 236 | Ground terminal |
| 238 | Communication circuitry |
| 240 | Processor |
| 300 | Bridge node |
| 302 | Communication circuitry |
| 304 | Functional circuitry |
| 306 | Input/output port |
| 308 | Input/output port |
| 310 | Input/output port |
| 312 | First circuit portion |
| 314 | Second circuit portion |
| 320 | First message |
| 320a | First message |
| 320b | First message |
| 330 | Second message |
| 400 | Serial communication network |
| 400a | Serial communication network |
| 400b | Serial communication network |
| 400c | Serial communication network |
| 400d | Serial communication network |
| 400e | Serial communication network |
| 400f | Serial communication network |
| 400g | Serial communication network |
| 400h | Serial communication network |
| 402 | Network node |
| 404 | Primary node |
| 406a | Secondary node |
| 406b | Secondary node |
| 406c | Secondary node |
| 406d | Secondary node |
| 408 | Control circuitry |
| 410 | Wired connection |
| 420 | Bridge node |
| 430 | Bridge node |
| 500 | Serial communication network |
| 502 | Network node |
| 504 | Primary node |
| 506a | Secondary node |
| 506b | Secondary node |
| 506c | Secondary node |
| 508 | Control circuitry |
| 510 | Wired connection |
| 520 | Bridge node |
| 540 | External device |
| 540a | External device |
| 540b | External device |
| 540c | External device |
| 542 | Wired connection |
| 550 | System |
| 550a | System |
| 550b | System |
| 600 | Message |
| 602 | Message field |
| 604 | Message field |
| 606 | Message field |
| 610 | Message |
| 612 | Message field |
| 614 | Message field |
| 620 | Data embedding scenario |
| 630 | Data embedding scenario |
| 640 | Data embedding scenario |
| 650 | Data embedding scenario |

1. A serial communication network, comprising:
a plurality of network nodes comprising a primary node and one or more secondary nodes,
wherein the plurality of network nodes are connected in a daisy chain configuration and are configured to communicate with one another according to a first wired communication protocol for serial communication,
wherein the first wired communication protocol is the Open System Protocol;
wherein at least one of the network nodes is configured to act as bridge node, wherein the bridge node comprises communication circuitry configured to:
enable a communicative coupling of the bridge node with at least one other network node and with an external device not part of the daisy chain of network nodes,
receive from the at least one other network node a first message configured according to the first wired communication protocol, and embed data from the first message into a second message configured according to a second wired communication protocol for transmission to the external device; and/or
receive from the external device a second message configured according to the second wired communication protocol, and embed data from the second message into a first message configured according to the first wired communication protocol for transmission to the at least one other network node,
wherein the second wired communication protocol is different from the first wired communication protocol.

2. The serial communication network according to claim 1,
wherein the one or more secondary nodes comprise a plurality of secondary nodes,
wherein the plurality of secondary nodes comprise an initial secondary node, a final secondary node, and one or more intermediate secondary nodes disposed between the initial secondary node and the final secondary node, and
wherein the bridge node is the initial secondary node, or the final secondary node, or one of the intermediate secondary nodes.

3. The serial communication network according to claim 1,
wherein the bridge node is configured to act as a buffer element to bridge differences in communication parameters between the first wired communication protocol and the second wired communication protocol.

4. The serial communication network according to claim 1,
wherein at least one secondary node comprises one or more light emitting elements and a driver circuit for controlling a light emission by the one or more light emitting elements.

5. The serial communication network according to claim 1,
wherein the primary node is configured to:
generate a first instruction message configured according to the first wired communication protocol,
wherein the first instruction message comprises instructions directed to the external device; and
cause the communication circuitry of the bridge node to embed the instructions into a second instruction message configured according to the second wired communication protocol and transmit the second instruction message to the external device.

6. The serial communication network according to claim 5,
wherein the instructions of the first instruction message are configured to prompt a response from the external device;
wherein the communication circuitry of the bridge node is configured to:
receive, from the external device, a second response message configured according to the second wired communication protocol;
embed a response from the second response message into a first response message configured according to the first wired communication protocol; and
cause a transmission of the first response message to the primary node.

7. The serial communication network according to claim 1,
wherein the bridge node further comprises a memory; and
wherein the communication circuitry of the bridge node is further configured to:
receive from the external device a second data message configured according to the second wired communication protocol,
extract data from the second data message; and
cause a storing of the extracted data in the memory.

8. The serial communication network according to claim 7,
wherein the communication circuitry of the bridge node is further configured to:
embed the data stored in the memory into a first data message configured according to the first wired communication protocol; and
cause a transmission of the first data message to the primary node.

9. The serial communication network according to claim 1
wherein the communication circuitry of the bridge node is further configured to:
receive from the external device a second data message configured according to the second wired communication protocol;
embed data from the second data message into a first data message configured according to the first wired communication protocol; and
cause a transmission of the first data message to the primary node.

10. The serial communication network according to claim 1,
wherein a further network node is configured to act as further bridge node,
wherein the further bridge node comprises communication circuitry configured to:
enable a communicative coupling of the further bridge node with at least one other network node and with a further external device not part of the daisy chain of network nodes,
receive from the at least one other network node a first message configured according to the first wired communication protocol, and embed data from the first message into a third message configured according to a third wired communication protocol for transmission to the further external device; and/or
receive from the further external device a third message configured according to the third wired communication protocol, and embed data from the third message into a first message configured according to the first wired communication protocol for transmission to the at least one other network node,
wherein the third wired communication protocol is different from the first wired communication protocol and from the second wired communication protocol.

11. The serial communication network according to claim 1,
wherein the first message configured according to the first communication protocol has a frame structure comprising a payload portion; and
wherein the communication circuitry of the bridge node is configured to embed information from the second message into the payload portion of the first message.

12. The serial communication network according to claim 1,
wherein the second communication protocol is the Inter-Integrated Circuit bus communication protocol.

13. A system comprising:
the serial communication network according to claim 1; and
the external device communicatively coupled with the bridge node.

14. The system according to claim 13,
wherein the external device is one of a sensor device, an actuator device, or a memory device.

15. An electronic device for use as bridge node in a daisy chain of network nodes, the electronic device comprising:
communication circuitry comprising a first circuit portion configured to carry out a first communication according to a first wired communication protocol for serial communication, and a second circuit portion configured to carry out a second communication according to a second wired communication protocol,
wherein the first wired communication protocol is different from the second wired communication protocol, and
wherein the first wired communication protocol is the Open System Protocol.

16. The electronic device according to claim 15,
wherein the electronic device is configured to act as a buffer element to bridge differences in communication parameters between the first wired communication protocol and the second wired communication protocol.

17. The electronic device according to claim 15, further comprising a memory; and
wherein the communication circuitry is further configured to:
receive a second data message configured according to the second wired communication protocol,
extract data from the second data message; and
cause a storing of the extracted data in the memory.

18. The electronic device according to claim 17,
wherein the communication circuitry is further configured to:
embed the data stored in the memory into a first data message configured according to the first wired communication protocol; and
cause a transmission of the first data message.

19. The electronic device according to claim 15,
wherein the communication circuitry is further configured to:
receive a second data message configured according to the second wired communication protocol;
embed data from the second data message into a first data message configured according to the first wired communication protocol; and
cause a transmission of the first data message.

20. The electronic device according to claim 15,
wherein the second communication protocol is the Inter-Integrated Circuit bus communication protocol.
